(19) United States
(12) Patent Application Publication
(10) Pub. No.: US 2020/0341284 A1
(43) Pub. Date: Oct. 29, 2020

(54) INFORMATION PROCESSING APPARATUS, INFORMATION PROCESSING METHOD, AND RECORDING MEDIUM

(71) Applicant: SONY CORPORATION, TOKYO (JP)

(72) Inventors: MIWA ICHIKAWA, TOKYO (JP); TAKESHI OGITA, TOKYO (JP); AKANE KONDO, TOKYO (JP); TAKAYOSHI SHIMIZU, CHIBA (JP); TAKURO NODA, TOKYO (JP); RIE KAMIKUBO, KANAGAWA (JP); RYO FUKAZAWA, KANAGAWA (JP); TOMOYA NARITA, KANAGAWA (JP)

(21) Appl. No.: 16/960,423

(22) PCT Filed: Dec. 13, 2018
(86) PCT No.: PCT/JP2018/045992

§ 371 Date: Jul. 7, 2020

(30) Foreign Application Priority Data
Jan. 18, 2018 (JP) 2018-006045

(51) Int. Cl. G02B 27/01; G02B 27/00

(52) U.S. Cl. CPC G02B 27/0179; G02B 27/0093; G02B 2027/014; G02B 2027/0187; G02B 2027/0138; G02B 27/0172

(57) ABSTRACT

[Problem] To make it possible to guide the line of sight of a user in a more preferable manner. [Solution] An information processing apparatus includes: an acquisition unit that acquires first information regarding guidance of a line of sight of a user; and a control unit that controls second information to be presented to the user so as to guide the line of sight of the user, wherein the control unit controls, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

### FIELD

The present disclosure relates to an information processing apparatus, an information processing method, and a recording medium.

### BACKGROUND

The technology called virtual reality (VR: Virtual Reality) that causes a user to perceive a virtual space as if it is the reality and the technology called virtual reality (VR: Virtual Reality) that superimposes additional information on the real world and presents it to the user have received attention in recent years. In this background, various considerations have been made on the user interface that assumes the use of the VR technology or the AR technology. For example, Patent Literature 1 discloses an example of the technique for executing the interaction between users using the AR technology.

### CITATION LIST

### Patent Literature

Patent Literature 1: WO 2014/162825 A1

### SUMMARY

### Technical Problem

With the use of the VR technology or the AR technology, the target information to be presented to the user may be localized in the expanded space that is wider than the field of view of the user as well as the range within the field of view (for example, presented in a desired position (coordinates) in the real space or in the virtual space). That is, in such a case, for example, the user may look around to change the position and the direction of the viewpoint so as to see the information localized in the space around him/her (for example, the information positioned outside his/her field of view).

Furthermore, when the information that needs to be noticed by the user is presented outside the field of view of the user (in other words, outside the range displayed on a display device such as a display), the user may be unaware of the presented information. In this background, there has been consideration on, for example, the introduction of the mechanism that, in a situation where the information to be presented is localized outside the field of view of the user, guides the line of sight of the user to the desired position (e.g., the position where the information is localized).

Thus, the present disclosure suggests the technique with which it is possible to guide the line of sight of the user in a more preferable manner.

### Solution to Problem

According to the present disclosure, an information processing apparatus is provided that includes: an acquisition unit that acquires first information regarding guidance of a line of sight of a user; and a control unit that controls second information to be presented to the user so as to guide the line of sight of the user, wherein the control unit controls, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

Moreover, according to the present disclosure, an information processing method is provided that causes a computer to execute: acquiring first information regarding guidance of a line of sight of a user; controlling second information to be presented to the user so as to guide the line of sight of the user; and controlling, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

Moreover, according to the present disclosure, a recording medium storing a program is provided that causes a computer to execute: acquiring first information regarding guidance of a line of sight of a user; controlling second information to be presented to the user so as to guide the line of sight of the user; and controlling, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

### Advantageous Effects of Invention

As described above, the present disclosure provides the technique with which it is possible to guide the line of sight of the user in a more preferable manner.

Furthermore, the above-described advantage is not necessarily a limitation, and any advantage mentioned in this description or other advantages that may be derived from this description may be achieved together with the above-described advantage or instead of the above-described advantage.

### BRIEF DESCRIPTION OF DRAWINGS

FIG. 1 is an explanatory diagram illustrating an example of the schematic configuration of an information processing system according to an embodiment of the present disclosure.

FIG. 2 is an explanatory diagram illustrating an example of the schematic configuration of an input/output device according to the embodiment.

FIG. 3 is an explanatory diagram illustrating the overview of the information processing system according to a first embodiment of the present disclosure.

FIG. 4 is an explanatory diagram illustrating the overview of the information processing system according to the embodiment.

FIG. 5 is a block diagram illustrating an example of the functional configuration of the information processing system according to the embodiment.

FIG. 6 is a flowchart illustrating an example of the flow of the series of processes in the information processing system according to the embodiment.

FIG. 7 is an explanatory diagram illustrating the overview of the information processing system according to a modification 1-1 of the embodiment.

FIG. 8 is an explanatory diagram illustrating the overview of the information processing system according to the modification 1-1 of the embodiment.

FIG. 9 is an explanatory diagram illustrating the overview of the information processing system according to the modification 1-1 of the embodiment.

FIG. 10 is an explanatory diagram illustrating the overview of the information processing system according to the modification 1-1 of the embodiment.

FIG. 11 is an explanatory diagram illustrating the overview of the information processing system according to a modification 1-2 of the embodiment.

FIG. 12 is an explanatory diagram illustrating the overview of the information processing system according to a modification 1-3 of the embodiment.

FIG. 13 is an explanatory diagram illustrating the overview of the information processing system according to the modification 1-3 of the embodiment.

FIG. 14 is an explanatory diagram illustrating the overview of the information processing system according to the modification 1-3 of the embodiment.

FIG. 15 is an explanatory diagram illustrating the overview of the information processing system according to a second embodiment of the present disclosure.

FIG. 16 is an explanatory diagram illustrating the overview of the information processing system according to the embodiment.

FIG. 17 is an explanatory diagram illustrating the overview of the information processing system according to the embodiment.

FIG. 18 is an explanatory diagram illustrating the overview of the information processing system according to the embodiment.

FIG. 19 is a flowchart illustrating an example of the flow of the series of processes in the information processing system according to the embodiment.

FIG. 20 is an explanatory diagram illustrating an example of the control regarding the guidance of the line of sight of a user by the information processing system according to the embodiment.

FIG. 21 is an explanatory diagram illustrating an example of the control regarding the guidance of the line of sight of a user by the information processing system according to the embodiment.

FIG. 22 is a functional block diagram illustrating an example of the hardware configuration of an information processing apparatus included in an information processing system according to an embodiment of the present disclosure.

### DESCRIPTION OF EMBODIMENTS

Preferred embodiments of the present disclosure are described below in detail with reference to the accompanying drawings. Furthermore, in the description and the drawings, the components having substantially the same function and configuration are denoted with the same reference numeral, and duplicated descriptions are omitted.

Furthermore, the descriptions are given in the following order.

1. Overview
1. 1. Schematic configuration
1. 2. Configuration of an input/output device
1. 3. Principle of self-location estimation

2. Consideration on guidance of the line of sight

3. First Embodiment
3. 1. Overview
3. 2. Functional configuration
3. 3. Process
3. 4. Modification
3. 5. Evaluation

4. Second Embodiment
4. 1. Overview
4. 2. Process
4. 3. Modification
4. 4. Evaluation

5. Hardware configuration

6. Conclusion

### 1. OVERVIEW

<1. 1. Schematic Configuration>

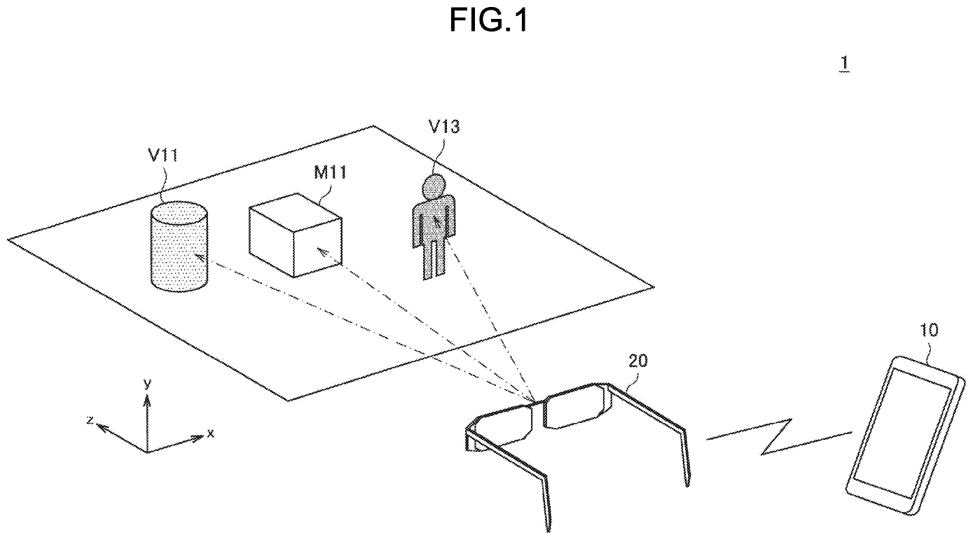

First, an example of the schematic configuration of an information processing system according to an embodiment of the present disclosure is described with reference to FIG. 1. FIG. 1 is an explanatory diagram illustrating an example of the schematic configuration of the information processing system according to an embodiment of the present disclosure. In FIG. 1, a reference numeral M11 schematically represents an object (i.e., a real object) located in the real space. Furthermore, reference numerals V11 and V13 schematically represent virtual contents (i.e., virtual objects) that are presented so as to be superimposed on the real space. In the example illustrated in FIG. 1, based on what is called the AR technology, for example, an information processing system 1 superimposes a virtual object on an object, such as the real object M11, in the real space and presents it to the user. Further, in FIG. 1, for easy understanding of the characteristics of the information processing system according to the present embodiment, both the real object and the virtual object are presented together.

As illustrated in FIG. 1, the information processing system 1 according to the present embodiment includes an information processing apparatus 10 and an input/output device 20. The information processing apparatus 10 and the input/output device 20 are configured so as to transmit/receive information to/from each other via a predetermined network. Furthermore, the type of network connecting the information processing apparatus 10 and the input/output device 20 is not particularly limited. In a specific example, the network may be configured by using what is called a wireless network, such as a network based on a standard such as Bluetooth (registered trademark) or Wi-Fi (registered trademark). Further, in another example, the network may be configured by using the Internet, a dedicated line, a LAN (Local Area Network), a WAN (Wide Area Network), or the like. Moreover, the network may include a plurality of networks, and a part of them may be configured as a wired network.

The input/output device 20 is configured to acquire various types of input information and to present various types of output information to a user who holds the input/output device 20. Further, the information processing apparatus 10 controls the presentation of the output information by the input/output device 20 based on the input information acquired by the input/output device 20. For example, the input/output device 20 acquires, as the input information, the information (e.g., the image of the captured real space) for recognizing the real object M11 and outputs the acquired information to the information processing apparatus 10. The information processing apparatus 10 recognizes the position of the real object M11 in the real space based on the information acquired from the input/output device 20 and causes the input/output device 20 to present the virtual objects V11 and V13 in accordance with the recognition result. Under such a control, the input/output device 20 may present the virtual objects V11 and V13 to the user such that the virtual objects V11 and V13 are superimposed with respect to the real object M11 based on what is called the AR technology.

Furthermore, in the example illustrated in FIG. 1, the input/output device 20 is configured as, for example, what is called a head mounted device that is attached to at least part of the user's head while in use and is configured so as to detect the line of sight of the user. With this configuration, for example, when the information processing apparatus 10 recognizes that the user is watching the desired target (e.g., the real object M11 or the virtual objects V11 and V13) in accordance with the detection result of the line of sight of the user by the input/output device 20, it may determine that the target is an operation target. Furthermore, the information processing apparatus 10 may determine that the object to which the line of sight of the user is directed is an operation target by using a predetermined operation on the input/output device 20 as a trigger. As described above, the information processing apparatus 10 may determine the operation target and execute the process associated with the operation target so as to provide the user with various services via the input/output device 20.

Furthermore, the information processing apparatus 10 may be configured as, for example, a wireless communication terminal such as a smartphone. Further, the information processing apparatus 10 may be configured as a device such as a server. Moreover, although the input/output device 20 and the information processing apparatus 10 are illustrated as different devices from each other in FIG. 1, the input/output device 20 and the information processing apparatus 10 may be integrally configured. Moreover, the configuration and the process of the input/output device 20 and the information processing apparatus 10 are described later in detail.

An example of the schematic configuration of the information processing system according to an embodiment of the present disclosure has been described above with reference to FIG. 1.

<1. 2. Configuration of the Input/Output Device>

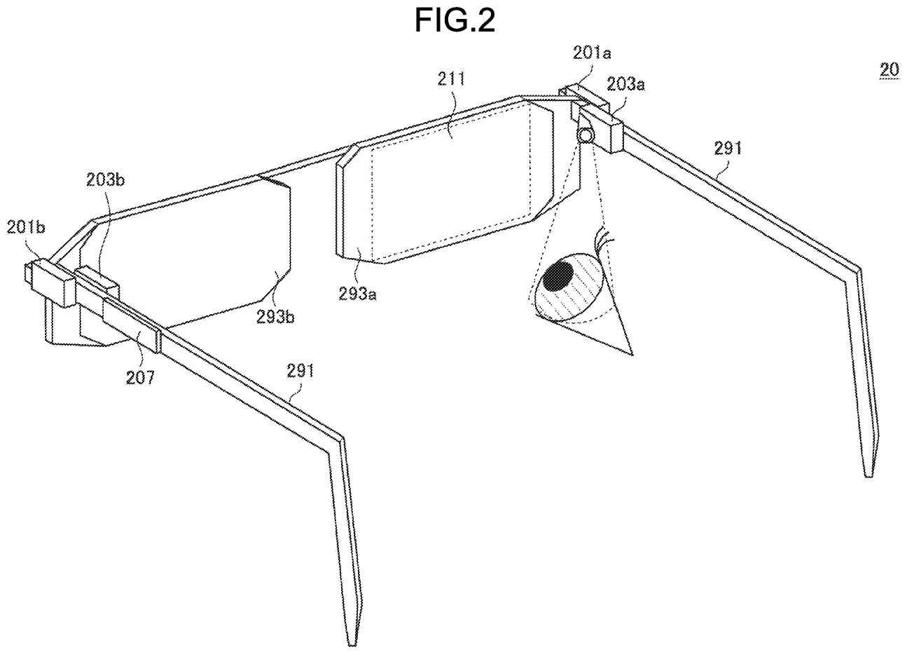

Next, an example of the schematic configuration of the input/output device 20 according to the present embodiment illustrated in FIG. 1 is described with reference to FIG. 2. FIG. 2 is an explanatory diagram illustrating an example of the schematic configuration of the input/output device according to the present embodiment.

As described above, the input/output device 20 according to the present embodiment is configured as what is called a head mounted device that is attached to at least part of the user's head while in use. For example, in the example illustrated in FIG. 2, the input/output device 20 is configured as what is called an eyewear type (glasses-type) device, and at least any one of lenses 293a and 293b is configured as a transmissive display (a display unit 211). Furthermore, the input/output device 20 includes first imaging units 201a and 201b, second imaging units 203a and 203b, an operating unit 207, and a holding unit 291 corresponding to the frame of the glasses. When the input/output device 20 is attached to the user's head, the holding unit 291 holds the display unit 211, the first imaging units 201a and 201b, the second imaging units 203a and 203b, and the operating unit 207 so as to have a predetermined positional relationship with respect to the user's head. Although not illustrated in FIG. 2, the input/output device 20 may include a voice collecting unit that collects the user's voice.

Here, a more detailed configuration of the input/output device 20 is described. For example, in the example illustrated in FIG. 2, the lens 293a corresponds to the lens on the side of the right eye, and the lens 293b corresponds to the lens on the side of the left eye. Specifically, when the input/output device 20 is mounted, the holding unit 291 holds the display unit 211 such that the display unit 211 (in other words, the lenses 293a and 293b) is positioned in front of the user's eye.

The first imaging units 201a and 201b are configured as what is called a stereo camera and, when the input/output device 20 is attached to the user's head, are held by the holding unit 291 so as to face in the direction (i.e., the front side of the user) in which the user's head faces. Here, the first imaging unit 201a is held near the user's right eye, and the first imaging unit 201b is held near the user's left eye. With this configuration, the first imaging units 201a and 201b capture the subject located in front of the input/output device (i.e., the real object located in the real space) from different positions. Thus, the input/output device 20 may acquire the image of the subject located in front of the user and may also calculate the distance from the input/output device 20 to the subject on the basis of the disparity between the images captured by the first imaging units 201a and 201b, respectively.

There is no particular limitation on the configuration and the method as long as the distance between the input/output device 20 and the subject may be measured. In a specific example, the distance between the input/output device 20 and the subject may be measured based on a method such as multi-camera stereo, movement disparity, TOF (Time Of Flight), or Structured Light. Here, the TOF is the method in which light such as infrared rays is projected to the subject and the time that elapses before the projected light is reflected by the subject and is returned is measured for each pixel so that the image (what is called a distance image) including the distance (depth) to the subject is obtained based on the measurement result. Furthermore, Structured Light is the method in which the subject is irradiated with a pattern with light such as infrared rays and it is captured so that a distance image including the distance (depth) to the subject is obtained based on a change in the pattern obtained from an imaging result. Further, the movement disparity is the method for measuring the distance to the subject based on the disparity even with what is called a monocular camera. Specifically, by moving the camera, the subject is captured from different viewpoints, and the distance to the subject is measured based on the disparity between the captured images. Moreover, various sensors recognize the moving distance and the moving direction of the camera so as to measure the distance to the subject more accurately. Here, the configuration of the imaging unit (e.g., a monocular camera or a stereo camera) may be changed depending on the method for measuring the distance.

Furthermore, the second imaging units 203a and 203b are held by the holding units 291, respectively, such that the eyeballs of the user are positioned within the respective imaging ranges when the input/output device 20 is attached to the user's head. In a specific example, the second imaging unit 203a is held such that the user's right eye is positioned within the imaging range. With this configuration, it is possible to recognize the direction in which the line of sight of the right eye is directed based on the image of the right eyeball captured by the second imaging unit 203a and the positional relationship between the second imaging unit 203a and the right eye. Similarly, the second imaging unit 203b is held such that the user's left eye is positioned within the imaging range. That is, it is possible to recognize the direction in which the line of sight of the left eye is directed based on the image of the left eyeball captured by the second imaging unit 203b and the positional relationship between the second imaging unit 203b and the left eye. Furthermore, in the example illustrated in FIG. 2, the input/output device 20 includes both the second imaging units 203a and 203b; however, only either one of the second imaging units 203a and 203b may be included.

The operating unit 207 is configured to receive an operation from the user with regard to the input/output device 20. The operating unit 207 may be configured by using an input device such as a touch panel or a button. The operating unit 207 is held at a predetermined position of the input/output device 20 by the holding unit 291. For example, in the example illustrated in FIG. 2, the operating unit 207 is held at the position corresponding to a temple of the glasses.

Furthermore, the input/output device 20 according to the present embodiment may be configured to include, for example, an acceleration sensor or an angular velocity sensor (gyro sensor) so as to detect the movement of the user's head wearing the input/output device 20 (in other words, the movement of the input/output device 20 itself). In a specific example, the input/output device 20 may detect each component in the yaw (yaw) direction, the pitch (pitch) direction, and the roll (roll) direction as the movement of the user's head to recognize a change in at least any of the position and the posture of the user's head.

With the above-described configuration, the input/output device 20 according to the present embodiment may recognize a change in its position or posture in the real space in accordance with the movement of the user's head. Furthermore, here, the input/output device 20 may cause the display unit 211 to present a virtual content (i.e., a virtual object) such that it is superimposed with respect to the real object located in the real space based on what is called the AR technology. Further, an example of the method (i.e., self-location estimation) with which the input/output device 20 estimates its position and posture in the real space is described in detail later.

Furthermore, examples of a head mounted display device (HMD: Head Mounted Display) that is appliable as the input/output device 20 include a see-through type HMD, a video see-through type HMD, and a retinal projection type HMD when the application of the AR technology is assumed.

The see-through type HMD uses, for example, a half mirror or a transparent light guide plate to hold a virtual-image optical system including a transparent light guide unit, or the like, in front of the user's eyes and displays an image on the inner side of the virtual-image optical system. Therefore, the user wearing the see-through type HMD may see the external scenery while watching the image displayed on the inner side of the virtual-image optical system. With this configuration, the see-through type HMD may superimpose the image of a virtual object on the optical image of the real object located in the real space in accordance with the recognition result of at least any one of the position and the posture of the see-through type HMD on the basis of, for example, the AR technology. Moreover, specific examples of the see-through type HMD include what is called a glasses-type wearable device in which the part corresponding to a lens of the glasses is configured as a virtual-image optical system. For example, the input/output device 20 illustrated in FIG. 2 corresponds to an example of the see-through type HMD.

When the video see-through type HMD is attached to the user's head or face, it is attached so as to cover the user's eyes, and a display unit such as a display is held in front of the user's eyes. Further, the video see-through type HMD includes an imaging unit that captures the surrounding scenery so as to cause the display unit to display the image of the scenery, captured by the imaging unit, in front of the user. With this configuration, although it is difficult for the user wearing the video see-through type HMD to directly see the external scenery, it is possible to check the external scenery by using the image displayed on the display unit. Moreover, here, the video see-through type HMD may superimpose a virtual object on the image of the external scenery in accordance with the recognition result of at least any one of the position and the posture of the video see-through type HMD based on, for example, the AR technology.

In the retinal projection type HMD, a projection unit is held in front of the user's eyes so that an image is projected by the projection unit to the user's eyes such that the image is superimposed on the external scenery. More specifically, in the retinal projection type HMD, the image is directly projected by the projection unit on the retina of the user's eye, and the image is focused on the retina. With this configuration, even a user having myopia or hypermetropia may view clearer images. Furthermore, the user wearing the retinal projection type HMD may see the external scenery while watching the image projected by the projection unit. With this configuration, the retinal projection type HMD may superimpose the image of a virtual object on the optical image of the real object located in the real space in accordance with the recognition result of at least any one of the position and the posture of the retinal projection type HMD based on, for example, the AR technology.

Furthermore, in addition to the example described above, it is also possible to apply an HMD called an immersive HMD when the application of the VR technology is assumed. As is the case with the video see-through type HMD, the immersive HMD is attached so as to cover the user's eyes, and a display unit such as a display is held in front of the user's eye. Thus, the user wearing the immersive HMD has difficulty in directly seeing the external scenery (i.e., the scenery in the real world) and therefore sees only the video displayed on the display unit. With this configuration, the immersive HMD may give a sense of immersion to the user who is viewing an image.

An example of the schematic configuration of the input/output device according to an embodiment of the present disclosure has been described above with reference to FIG. 2.

<1. 3. Principle of Self-Location Estimation>

Next, an example of the principle of the method (i.e., self-location estimation) for estimating the position and the posture of the input/output device 20 in the real space when the virtual object is superimposed with respect to the real object is described.

According to a specific example of the self-location estimation, the input/output device 20 uses an imaging unit, such as a camera, provided therein to capture a marker, or the like, having a known size and presented on the real object in the real space. Then, the input/output device 20 analyzes the captured image to estimate at least any one of the position and the posture of its own relative to the marker (and furthermore the real object on which the marker is presented). Furthermore, the following description focuses on the case in which the input/output device 20 estimates its position and posture; however, the input/output device 20 may estimate only any one of the position and the posture of its own.

Specifically, it is possible to estimate the direction of the imaging unit (and furthermore the input/output device 20 including the imaging unit) relative to the marker in accordance with the direction of the marker captured in the image (e.g., the direction of the pattern of the marker). Furthermore, in the case where the size of the marker is known, the distance between the marker and the imaging unit (i.e., the input/output device 20 including the imaging unit) may be estimated in accordance with the size of the marker in the image. More specifically, when the marker is captured in a long distance, the marker having a smaller size is captured. Further, here, the range of the real space captured in the image may be estimated based on the angle of view of the imaging unit. With the use of the above features, it is possible to inversely calculate the distance between the marker and the imaging unit in accordance with the size of the marker captured in the image (in other words, the percentage occupied by the marker within the angle of view). With the above-described configuration, the input/output device 20 may estimate its position and posture relative to the marker.

Furthermore, the technique called SLAM (simultaneous localization and mapping) may be used for the self-location estimation of the input/output device 20. The SLAM is a technique using an imaging unit, such as a camera, various sensors, an encoder, or the like, to perform the self-location estimation and the generation of an environment map in parallel. In a more specific example, in the SLAM (in particular, Visual SLAM), the three-dimensional shape of the captured scene (or the subject) is sequentially restored based on the moving image captured by the imaging unit. Then, the restoration result of the captured scene is associated with the detection result of the position and the posture of the imaging unit so that the map of the surrounding environment is generated and the position and the posture of the imaging unit (and furthermore the input/output device 20) in the environment are estimated. For example, the input/output device 20 may include various sensors such as an acceleration sensor and an angular velocity sensor to estimate the position and the posture of the imaging unit as the information indicating a relative change based on detection results of the sensors. It is obvious that, as long as the position and the posture of the imaging unit may be estimated, the method is not necessarily limited to the method based on detection results of various sensors such as an acceleration sensor and an angular velocity sensor.

With the above configuration, for example, the estimation results of the position and the posture of the input/output device 20 relative to the marker based on the capturing result of the known marker by the imaging unit may be used for the initialization processing and the position correction for the above-described SLAM. With this configuration, even in a situation where the marker is not included in the angle of view of the imaging unit, the input/output device 20 may estimate its position and posture relative to the marker (and furthermore the real object for which the marker is presented) due to the self-location estimation based on the SLAM in accordance with the result of the previously executed initialization or position correction.

An example of the principle of the method (i.e., the self-location estimation) for the input/output device 20 to estimate its position and posture in the real space when the virtual object is superimposed with respect to the real object has been described above. Furthermore, in the following description, for example, the position and the posture of the input/output device 20 relative to an object (the real object) in the real space may be estimated based on the above-described principle.

### 2. CONSIDERATION ON GUIDANCE OF THE LINE OF SIGHT

Next, the overview of the guidance for the line of sight of the user in the assumed case of the use of the AR technology or the VR technology is described. Furthermore, the term “localize” in this description refers to being located or being presented to be located at a position (in other words, coordinates) in a desired space, such as the real space or a virtual space. Furthermore, the term “localize” may include not only a stationary state in a desired space but also, for example, a moving state along a route in a desired space. For example, the description of a desired object being localized along a predetermined route may include the object being presented so as to move along the route.

When information is presented to a user via a display device such as a display, for example, the position where the target information to be presented is localized is sometimes limited to the range defined in the display screen of the display device. On the other hand, when the VR technology or the AR technology is used, the target information to be presented to the user is not limited to the range within the field of view of the user but may be also localized within the expanded space (for example, around the user) that is wider than the field of view.

In a specific example, when the use of the AR technology is assumed, an object that is virtual (hereinafter, also referred to as “virtual object”) may be presented to the user such that the object is localized not only within the range of the field of view of the user but also in the real space that spreads around the user. In this case, for example, the user may see the virtual object localized in the space around him/her (e.g., the virtual object located outside of his/her own field of view) while changing the position or the direction of the viewpoint so as to look around. Furthermore, even in the case of the use of the VR technology, the information may be presented to the user in substantially the same manner as is the case with the use of the AR technology except that the virtual space is used instead of the real space.

However, when the information that needs to be noticed by the user is presented outside the field of view of the user (in other words, outside the range displayed on the display device such as a display), the user is sometimes unaware of the presented information. In this background, for a situation where the target information to be presented is localized outside the field of view of the user, as in the case of the use of the AR technology or the VR technology, for example, there is sometimes demand for the introduction of the mechanism that guides the user's line of sight to a desired position (for example, the position where the information is localized).

Therefore, the present disclosure suggests an example of the technique for guiding the line of sight of the user in a more preferable manner in a situation where the user sees the information presented so as to be localized around him/her while flexibly changing the position and the direction of the viewpoint. In particular, the present disclosure suggests an example of the mechanism that may reduce a load (e.g., a mental load or a physical load) on the user in accordance with the following when the user causes the line of sight to follow the guidance.

### 3. FIRST EMBODIMENT

Hereinafter, an information processing system according to a first embodiment of the present disclosure is described.

<3. 1. Overview>

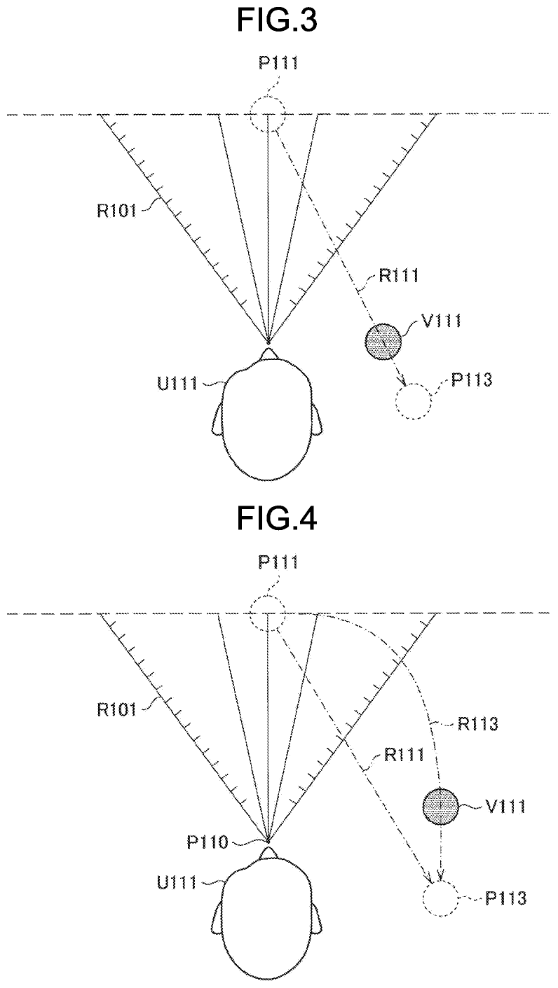

First, the overview of the information processing system according to the present embodiment is described. For example, FIG. 3 and FIG. 4 are explanatory diagrams illustrating the overview of the information processing system according to the present embodiment and illustrating an example of the method for guiding the line of sight of the user. In FIG. 3 and FIG. 4, the reference numeral R101 schematically indicates the field of view of a user U111. Specifically, the reference numeral P110 indicates the position of the viewpoint (hereinafter, simply referred to as “viewpoint”) of the user U111. Furthermore, in the following description, the position of the viewpoint of the user is also referred to as “viewpoint position” as in the position P110. Further, the reference numeral V111 schematically indicates the display information (hereinafter, also referred to as “guidance object”) presented to guide the line of sight of the user. The guidance object V111 is presented to the user U111 via the display unit (e.g., the display unit 211 illustrated in FIG. 2), such as a display.

Specifically, FIG. 3 illustrates an example of the case in which the line of sight of the user U111 paying attention to the position indicated by the reference numeral P111 within the field of view R101 is guided to a position P113 outside the field of view R101 due to the presentation of the guidance object V111. Specifically, the position P111 is a position substantially corresponding to the point of gaze of the user U111 before the guidance of the line of sight is started. That is, in the example illustrated in FIG. 3, the guidance object V111 is first presented at the position P111, and the presentation of the guidance object V111 to the user U111 is controlled such that the guidance object P111 is moved from the point of gaze P111 to the position P113. Furthermore, in the following description, the position at which the guidance of the line of sight is started, such as the position P111, is also referred to as “start position”, and the position to which the line of sight is guided, i.e., the position at which the guidance of the line of sight is ended, such as the position P113, is also referred to as “end position”.

For example, in the example illustrated in FIG. 3, the presentation of the guidance object V111 is controlled such that the guidance object V111 is localized along a route R111 connecting the start position P111 and the end position P113 with a straight line (that is, the guidance object V111 is moved along the route R111). However, in the example illustrated in FIG. 3, the guidance object V111 may be presented to the user U111 in such an expression that it passes through the user U111 or it passes near the user U111 in accordance with the positional relationship among the viewpoint position P100, the start position P111 (i.e., the point of gaze), and the end position P113 (i.e., the guidance destination). That is, the guidance object V111 is presented to the user U111 in such an expression that the guidance object V111 moves toward him/her and passes through the his/her body. In such a situation, the user U111 may feel uncomfortable.

Therefore, the information processing system according to the present embodiment controls the presentation of the guidance object V111 such that the guidance object V111 is localized along the route for which the user U111 has a lower following load with regard to the guidance object V111.

For example, FIG. 4 illustrates an example of the control regarding the guidance of the line of sight of the user U111 in the information processing system according to the present embodiment. Furthermore, in FIG. 4, the target denoted by the same reference numeral as that in FIG. 3 indicates the same target as that in FIG. 3. For example, in the example illustrated in FIG. 4, when the route R111 connecting the distance between the start position P111 and the end position P111 with a straight line is set in the same manner as that in the example illustrated in FIG. 3, the guidance object V111 passes through an area near the user U111.

Therefore, in the situation illustrated in FIG. 4, the information processing system according to the present embodiment controls the presentation of the guidance object V111 such that the guidance object V111 is localized along the route for which the user U111 has a lower following load (e.g., a physical load or a mental load) with regard to the guidance object V111. Specifically, in the example illustrated in FIG. 4, the information processing system sets, as the route along which the guidance object V111 is moved, a route R113 farther away from the user U111 (i.e., the route farther away from the viewpoint position P100) among a plurality of routes connecting the start position P111 and the end position P113.

Under such a control, the guidance object V111 is controlled so as to move from the start position P111 to the end position P113 while the separate state between the user U111 and the guidance object V111 is maintained. That is, it is possible to prevent the occurrence of a situation in which the guidance object V111 is presented to the user U111 in such an expression that the guidance object V111 is moved toward the user U111 and is eventually passed through the user U111. Thus, it is possible to reduce the following load on the user with regard to the guidance object V111, as compared with the case where the guidance object V111 is controlled so as to be localized along the route R111.

The overview of the information processing system according to the present embodiment has been described above with reference to FIG. 3 and FIG. 4.

<3. 2. Functional Configuration>

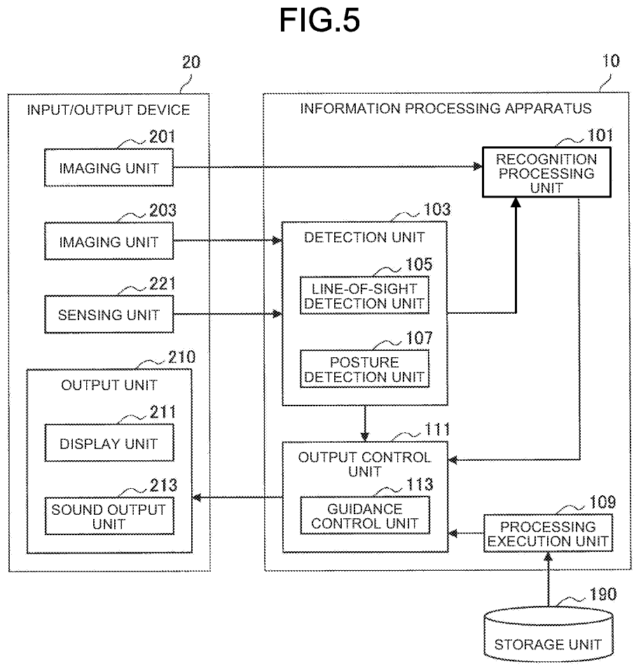

Next, an example of the functional configuration of the information processing system according to the present embodiment is described with reference to FIG. 5. FIG. 5 is a block diagram illustrating an example of the functional configuration of the information processing system according to the present embodiment. Furthermore, in this description, an example of the configuration of the information processing system is described with a focus on the case where the information processing system uses the AR technology to present information to the user.

As illustrated in FIG. 5, the information processing system 1 includes the input/output device 20, the information processing apparatus 10, and a storage unit 190. Here, the input/output device 20 and the information processing apparatus 10 correspond to, for example, the input/output device 20 and the information processing apparatus 10 in the example illustrated in FIG. 1.

The input/output device 20 includes, for example, imaging units 201 and 203, a sensing unit 221, and an output unit 210. Furthermore, the imaging unit 201 corresponds to the first imaging units 201a and 201b in the example illustrated in FIG. 2. Further, the imaging unit 203 corresponds to the second imaging units 203a and 203b in the example illustrated in FIG. 2. That is, the imaging unit 201 and the imaging unit 203 are substantially the same as those in the example described with reference to FIG. 2, and therefore detailed descriptions thereof are omitted.

The sensing unit 221 is configured to sense various states. For example, the sensing unit 221 may include an acceleration sensor, an angular velocity sensor, an orientation sensor, or the like, and use the sensor to sense the movement of the site (e.g., the head) of the user wearing the input/output device 20 (and furthermore the direction in which the site of the user faces). Furthermore, the sensing unit 221 may include a receiver corresponding to the GNSS (Global Navigation Satellite System), or the like, to sense the position of the input/output device 20 (and furthermore the position of the user). Further, the sensing unit 221 may include a biological sensor, or the like, and use the biological sensor to sense various states of the user. Moreover, the sensing unit 221 notifies the information processing apparatus 10 of the information corresponding to a sensing result of various states.

The output unit 210 corresponds to an output interface to present various types of information to the user. For example, the output unit 210 may include the display unit 211. Furthermore, the display unit 211 corresponds to the display unit 211 in the example illustrated in FIG. 2 and therefore detailed descriptions are omitted. Further, the output unit 210 may include a sound output unit 213. The sound output unit 213 is configured by using a sound output device such as a speaker to output voice or sound so as to present desired information to the user.

The information processing apparatus 10 includes a recognition processing unit 101, a detection unit 103, a processing execution unit 109, and an output control unit 111.

The image captured by the imaging unit 201 is acquired, and the acquired image is subjected to an analysis process so as to recognize an object (subject) present in the real space and captured in the image. In a specific example, the recognition processing unit 101 acquires images (hereinafter, also referred to as “stereo images”) captured at different viewpoints from the imaging unit 201 configured as a stereo camera and measures the distance to the object captured in the image for each pixel of the image based on the disparity between the acquired images. Thus, the recognition processing unit 101 may estimate or recognize the relative positional relationship (in particular, the positional relationship in the depth direction) between the imaging unit 201 (and furthermore the input/output device 20) and each object present in the real space and captured in the image at the timing in which the image is captured.

Furthermore, the recognition processing unit 101 may perform the self-location estimation and the generation of the environment map based on the SLAM to recognize the positional relationship between the input/output device 20 and the object present in the real space and captured in the image. In this case, for example, the recognition processing unit 101 may acquire the information corresponding to the detection result of a change in the position and the posture of the input/output device 20 from the detection unit 103 (e.g., an posture detection unit 107), which is described later, and use the information for the self-location estimation based on the SLAM.

As described above, the recognition processing unit 101 recognizes the position of each object present in the real space and captured in the image and outputs the information indicating the recognition result to the output control unit 111.

Furthermore, as described above, the method for measuring the distance to the subject is not limited to the above-described measurement method based on a stereo image. Therefore, the configuration corresponding to the imaging unit 201 may be changed as appropriate in accordance with the method for measuring the distance. In a specific example, in a case where the distance to the subject is measured based on the TOF, it is possible to provide, instead of the imaging unit 201, a light source that projects infrared rays and a light receiving element that detects infrared rays projected from the light source and reflected by the subject. Furthermore, a plurality of measurement methods may be used to measure the distance to the object. In this case, the input/output device 20 or the information processing apparatus 10 may include the configuration that acquires the information to be used for the measurement in accordance with the measurement method to be used. It is obvious that the content of the information (e.g., depth map) indicating the recognition result of the real-space position of each object captured in the image may be changed as appropriate in accordance with the measurement method to be applied.

The detection unit 103 detects various states of the user holding the input/output device 20 (for example, the user wearing the input/output device 20) based on various types of information acquired by the input/output device 20. For example, the detection unit 103 includes a line-of-sight detection unit 105 and the posture detection unit 107.

The line-of-sight detection unit 105 detects the direction in which the line of sight of the user is directed based on the image of the user's eyeball captured by the imaging unit 203. Here, as an example of the method for detecting the line of sight of the user has been described above with reference to FIG. 2, a detailed description is omitted. Furthermore, the line-of-sight detection unit 105 outputs the information corresponding to the detection result of the line of sight of the user to the output control unit 111.

The posture detection unit 107 detects the position and the posture (hereinafter, also simply referred to as “posture”) of the site of the user holding the input/output device 20 in accordance with a detection result of various states by the sensing unit 221. For example, the posture detection unit 107 may detect a change in the posture of the input/output device 20 in accordance with the detection result of the acceleration sensor or the angular velocity sensor held by the input/output device 20 configured as a head mounted device so as to detect the posture of the user's head wearing the input/output device 20. Similarly, the posture detection unit 107 may detect a change in the posture of the site, such as the user's hand, arm, or leg, in accordance with the detection result of the acceleration sensor or the angular velocity sensor held by the site. It is obvious that the above is merely an example and, as long as the posture of the site of the user may be detected, there is no particular limitation on the target site for the posture detection and the method for detecting the posture of the site. That is, the configuration for detecting the posture of the site and the detection method may be changed as appropriate depending on the target site for the posture detection. Furthermore, the posture detection unit 107 outputs the information corresponding to the detection result of the posture of the site of the user to the output control unit 111.

The processing execution unit 109 is configured to execute various functions (e.g., applications) provided by the information processing apparatus 10 (and furthermore the information processing system 1). For example, the processing execution unit 109 may extract the target application to be executed from a predetermined storage unit (for example, the storage unit 190 described later) in accordance with a predetermined trigger such as a user input and execute the extracted application. Furthermore, the processing execution unit 109 may give a command to the output control unit 111 so as to make an upstream output in accordance with the execution result of the application. In a specific example, the processing execution unit 109 may give a command to the output control unit 111 so as to present display information such as a virtual object such that the virtual object is localized at a desired position in the real space in accordance with the execution result of the application.

The output control unit 111 controls the output unit 210 so as to output various types of information, which is the target to be output, and thus present the information to the user. For example, the output control unit 111 may cause the output unit 210 to output the information corresponding to the execution result of the application by the processing execution unit 109 so as to present the information corresponding to the execution result to the user. In a more specific example, the output control unit 111 may control the display unit 211 so as to present the display information, which is the target to be output, and thus present the display information to the user. Moreover, the output control unit 111 may control the sound output unit 213 so as to output the sound corresponding to the information to be output and thus present the information to the user.

Furthermore, the output control unit 111 may cause the display unit 211 to display the display information, such as a virtual object, such that the display information is localized in the real space in accordance with the recognition result of the object in the real space by the recognition processing unit 101 (in other words, the result of the self-location estimation of the input/output device 20 in the real space). In this case, for example, the output control unit 111 estimates the area in the real space in which the information displayed on the display unit 211 is superimposed (in other words, the area included in the field of view of the user) in accordance with the result of the self-location estimation of the input/output device 20 to recognize the positional relationship between the area and the display information localized in the real space. Then, the output control unit 111 performs control such that the display information localized in the area is displayed at the corresponding position in the display area of the display unit 211 in accordance with the recognition result of the positional relationship between the area and the display information.

Specifically, the output control unit 111 calculates, for example, the position and the range of the area displayed on the display unit 211 in the real space in accordance with the position and the posture of the input/output device 20 (the display unit 211) in the real space. This makes it possible to recognize the positional relationship in the real space between the area displayed on the display unit 211 and the position in which the display information to be presented is localized. Then, the output control unit 111 may calculate the position in the screen on which the display information is displayed in accordance with the positional relationship between the area displayed on the display unit 211 and the position where the display information to be presented is localized. Furthermore, the coordinate associated with a position in the screen of the display unit 211 (i.e., the coordinate associated with the display unit 211) corresponds to an example of a “first coordinate”, and the coordinate associated with a position in the real space corresponds to an example of a “second coordinate”.

Furthermore, the output control unit 111 includes a guidance control unit 113. The guidance control unit 113 presents information to the user through the output unit 210 to control the guidance of the line of sight of the user. Here, the guidance control unit 113 may use the detection result by the line-of-sight detection unit 105 with regard to the direction in which the line of sight of the user is directed and the detection result by the posture detection unit 107 with regard to the posture of the site of the user for the guidance of the line of sight of the user. In a specific example, the guidance control unit 113 may recognize the positional relationship among the position of the viewpoint P110, the start position P111 (e.g., the point of gaze), and the end position P113 (i.e., the guidance destination of the line of sight) in the example illustrated in FIG. 4 in accordance with the result of the self-location estimation of the input/output device 20. Thus, for example, the guidance control unit 113 may set the route R113 for guiding the line of sight in accordance with the recognition result of the positional relationship and control the presentation of the guidance object V111 to the user such that the guidance object V111 is localized along the route R113.

Furthermore, the operation regarding the guidance of the line of sight of the user is not limited to the example described with reference to FIG. 4. Therefore, another example of the operation regarding the guidance of the line of sight of the user is separately described later as a modification. Further, the user's self-location (i.e., the position of the viewpoint P110), the detection result of the user's line of sight, the posture of the site of the user, and the like, correspond to an example of “first information” regarding the guidance of the user's line of sight, and the guidance object V111 corresponds to an example of “second information”. That is, for example, the part of the output control unit 111 regarding the acquisition of the above-described first information corresponds to an example of an “acquisition unit”, and the guidance control unit 113 corresponds to an example of a “control unit”. Furthermore, the route, such as the route R111 illustrated in FIG. 4, connecting the start position and the end position with a straight line corresponds to an example of a “first route”, and the route, such as the route R113, away from the user as compared with the first route corresponds to an example of a “second route”.

The storage unit 190 is a storage area for temporarily or permanently storing various types of data. For example, the storage unit 190 may store the data for the information processing apparatus 10 to execute various functions. In a more specific example, the storage unit 190 may store the data (for example, libraries) for executing various applications, management data for managing various settings, and the like.

Furthermore, the above-described functional configuration of the information processing system 1 according to the present embodiment is merely an example, and the functional configuration of the information processing system 1 is not necessarily limited to the example illustrated in FIG. 3 as long as each function of the input/output device 20 and the information processing apparatus 10 described above may be performed. In a specific example, the input/output device 20 and the information processing apparatus 10 may be integrally configured.

Furthermore, a part of the components of the information processing apparatus 10 may be provided in a different device. In a specific example, the recognition processing unit 101 and the detection unit 103 may be provided in a different device (for example, the input/output device 20 or a device different from the information processing apparatus 10 or the input/output device 20). Similarly, a part of the components of the input/output device 20 may be provided in a different device.

Furthermore, each function of the information processing apparatus 10 may be performed by a plurality of apparatuses operating in cooperation. In a specific example, the function provided by each component of the information processing apparatus 10 may be provided by a virtual service (e.g., a cloud service) performed by a plurality of apparatuses operating in cooperation. In this case, the service corresponds to the above-described information processing apparatus 10. Similarly, each function of the input/output device 20 may be performed by a plurality of devices operating in cooperation.

An example of the functional configuration of the information processing system according to the present embodiment has been described above with reference to FIG. 5.

<3. 3. Process>

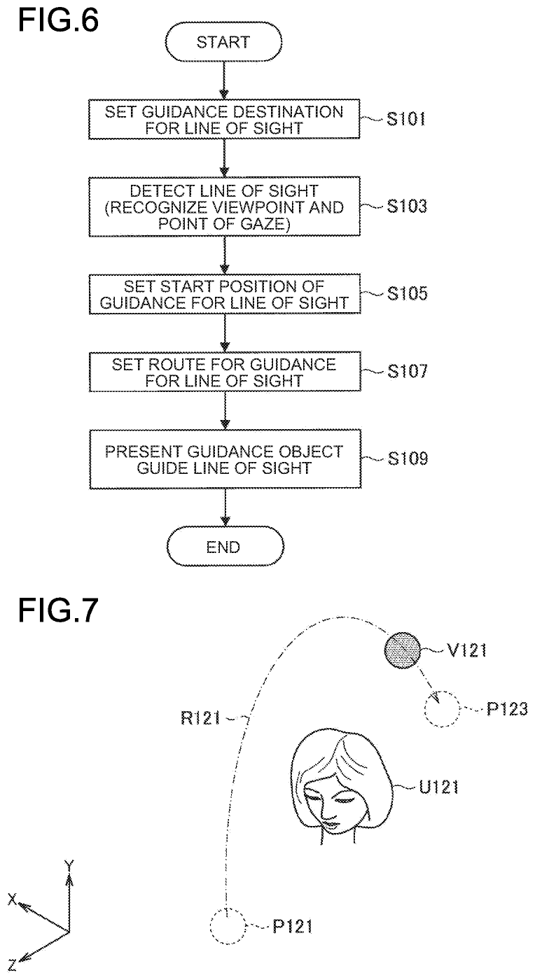

Next, with reference to FIG. 6, an example of the flow of the series of processes in the information processing system according to the present embodiment is described with a focus on, particularly, the operation regarding the guidance of the line of sight of the user by the information processing apparatus 10. FIG. 6 is a flowchart illustrating an example of the flow of the series of processes in the information processing system according to the present embodiment.

First, the information processing apparatus 10 (the guidance control unit 113) sets the guidance destination for the line of sight (S101). For example, the information processing apparatus 10 may set, as the guidance destination of the line of sight of the user, the position where the display information (e.g., a virtual object), which needs to be noticed by the user, is localized. In a more specific example, the information processing apparatus 10 may set, as the guidance destination of the line of sight of the user, the position where the virtual object is localized based on the execution result of a desired application.

Subsequently, the information processing apparatus 10 (the line-of-sight detection unit 107) detects the line of sight of the user based on various types of information acquired by the input/output device 20 and recognizes the positions of the viewpoint and the point of gaze based on the detection result (S103). In a specific example, the information processing apparatus 10 may recognize the direction of the line of sight of the user in accordance with the imaging result by the imaging unit 203 held by the input/output device 20 with regard to the eyeball of the user. Further, the information processing apparatus 10 (the recognition processing unit 101) estimates the self-location of the input/output device 20 (and furthermore the self-location of the user) in the real space in accordance with the imaging result by the imaging unit 201 held by the input/output device 20 with regard to the environment around the user. Furthermore, the information processing apparatus 10 (the guidance control unit 113) recognizes the position (i.e., the point of gaze) in the real space to which the user directs the line of sight based on the self-location of the user and the direction of the line of sight of the user. Moreover, the self-location of the user may correspond to the position of the viewpoint of the user.

Next, the information processing apparatus 10 (the guidance control unit 113) sets the start position of the guidance for the line of sight of the user (S105). For example, the information processing apparatus 10 may set the recognized point of gaze as the above-described start position. Furthermore, the information processing apparatus 10 may recognize the area (i.e., the area displayed on the display unit 211) in the real space corresponding to the field of view of the user in accordance with the recognition result of the point of gaze and the line of sight and set the above-described start position in the field of view.

After the start position of the guidance for the line of sight of the user is set, the information processing apparatus 10 (the guidance control unit 113) sets the route connecting the start position and the end position, which is the guidance destination of the line of sight, as the route for the guidance for the line of sight (S107). Here, as illustrated in for example FIG. 4, the information processing apparatus 10 may set the route for guiding the line of sight of the user in consideration of the position of the viewpoint of the user. In a more specific example, the information processing apparatus 10 may set a plurality of routes connecting the start position and the end position and select the route for guiding the line of sight of the user from the plurality of routes in accordance with the position of the viewpoint of the user.

Then, the information processing apparatus 10 (the guidance control unit 113) presents the guidance object V111 to the user in accordance with the setting results of the start position of the line-of-sight guidance and the route so as to guide the line of sight of the user (S109). In a specific example, the information processing apparatus 10 first localizes the guidance object V111 at the set start position. Subsequently, the information processing apparatus 10 performs control such that the guidance object V111 localized at the start position is localized along the set route (i.e., moved along the route). Under such a control, there is an expected effect that the line of sight of the user is guided so as to follow the movement of the guidance object V111.

With reference to FIG. 6, an example of the flow of the series of processes in the information processing system according to the present embodiment has been described above with a focus on, particularly, the operation regarding the guidance of the line of sight of the user by the information processing apparatus 10.

<3. 4. Modification>

Next, a modification of the information processing system according to the present embodiment is described.

(Modification 1-1: Example of the Setting of the Route for the Line-of-Sight Guidance)

First, as a modification 1, an example of the method for setting a route to guide the line of sight of the user is described. For example, FIG. 7 to FIG. 10 are explanatory diagrams illustrating the overview of the information processing system according to a modification 1-1 of the present embodiment and illustrating an example of the route setting regarding the guidance of the line of sight. Furthermore, in the example illustrated in FIG. 7 to FIG. 10, the right-left direction of the user is an x-direction, the up-down direction of the user is a y-direction, and the front-back direction of the user is a z-direction.

For example, in some positional relationships between the point of gaze (i.e., the start position) of the user and the position (i.e., the end position) that is the guidance destination of the line of sight, the user moves his/her own site (e.g., neck or head) largely in order to cause the line of sight to follow the guidance object, which may accordingly cause the user to feel a feeling of fatigue.

For example, FIG. 7 and FIG. 8 illustrate an example of the case in which the line of sight of a user U121 is guided from a start position P121 located in front of the user U121 to an end position P123 located behind the user U121. Specifically, in the example illustrated in FIG. 7 and FIG. 8, a route R121 making a detour above the head of the user U121 is set as the route connecting from the start position P121 to the end position P123, and a guidance object V121 is controlled to be localized along the R121. In such a situation, the user largely moves his/her neck and head up and down. This action of moving the neck or head up and down imposes a load on the user and, as a result, the user may feel a feeling of fatigue.

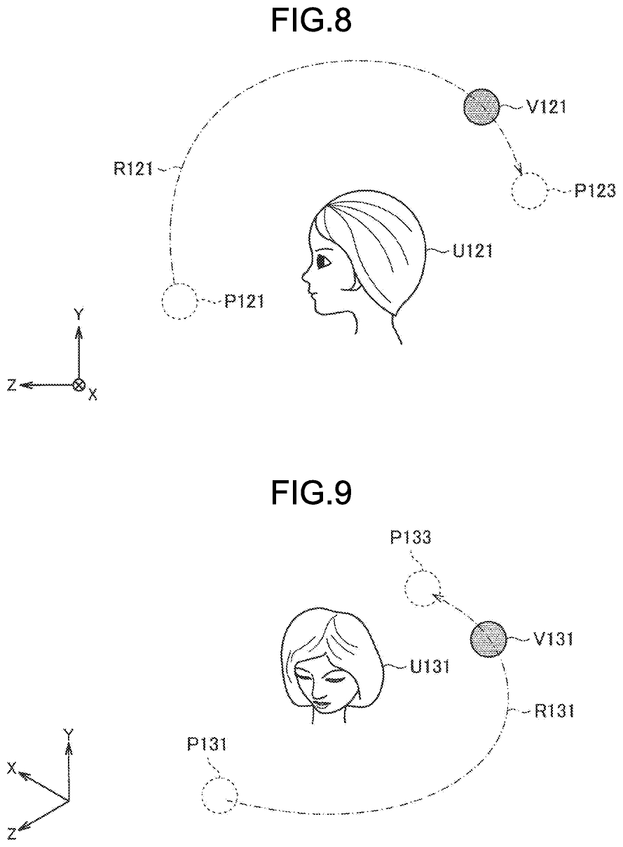

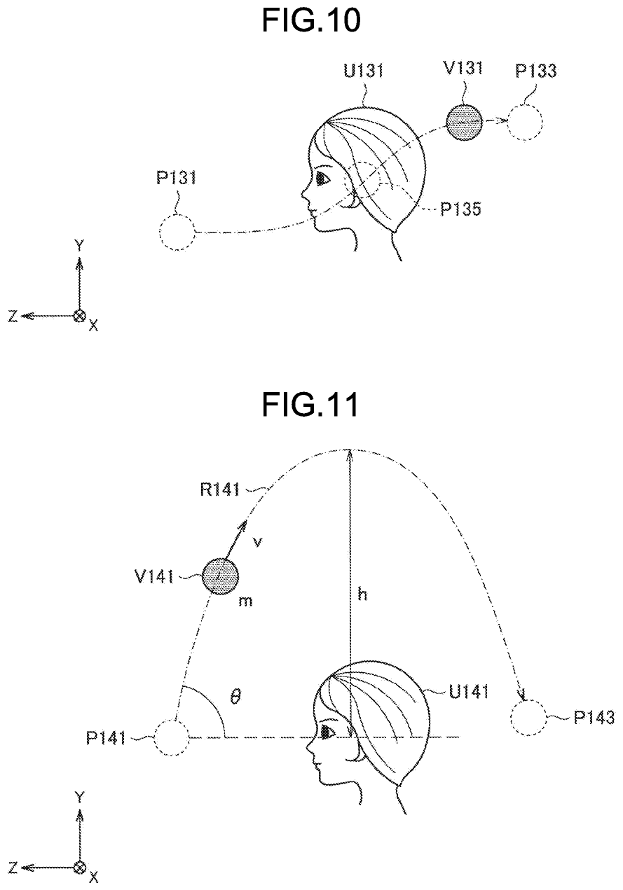

In consideration of the above situation, the information processing system according to the present modification sets the route having a low load on the user is selected as the route for guiding the line of sight of the user. For example, FIG. 9 and FIG. 10 illustrate an example of the case in which the line of sight of a user U131 is guided from a start position P131 located in front of the user U131 to an end position P133 located behind the user U131, as is the case with the example illustrated in FIG. 7 and FIG. 8.

However, the example illustrated in FIG. 9 and FIG. 10 is different from the example illustrated in FIG. 7 and FIG. 8 in the setting of a route R131 (i.e., the route along which a guidance object V131 is localized) regarding the guidance of the line of sight of the user U131. Specifically, in the example illustrated in FIG. 9 and FIG. 10, the route R131 making a detour alongside the head of the user U131 is set as the route connecting the start position P131 to the end position P133. Thus, the user U131 does not need to largely move his/her neck or head up and down in order to cause the line of sight to follow the guidance object V131. Furthermore, in consideration of the range of motion of the human neck, the user is unlikely to feel a feeling of fatigue when the user moves his/her head from side to side as illustrated in FIG. 9 and FIG. 10, as compared with the case where the user moves his/her head up and down as illustrated in FIG. 7 and FIG. 8.

Furthermore, as illustrated in FIG. 10, the route R131 may be set so as to form a gentle curve (e.g., Bèzier curve) by using, as the base point, a position P135 corresponding to the level of the ear of the user U131 (for example, the position corresponding to the side of the ear of the user U131). Under such a control, it is possible to further reduce the load on the user U131 due to the following of the line of sight to the guidance object V131.

Furthermore, the examples described with reference to FIG. 9 and FIG. 10 are merely examples and do not necessarily limit the operation regarding the setting of the guidance route for the line of sight by the information processing system according to the present modification. That is, there is no particular limitation on the route to be set and the method for setting the route as long as the movement of the site in the case where the user causes the line of sight to follow the guidance object is estimated and the route that causes the user to be less likely to feel a feeling of fatigue (i.e., the route having a lower load on the user) is set.

An example of the method for setting the route for guiding the line of sight of the user has been described above as the modification 1-1 with reference to FIGS. 7 to 10.

(Modification 1-2: Example of the Control Regarding the Presentation of the Guidance Object)

Next, an example of the control regarding the presentation of the guidance object is described as a modification 1-2. For example, FIG. 11 is an explanatory diagram illustrating the overview of the information processing system according to a modification 1-2 of the present embodiment.

FIG. 11 illustrates an example of the case in which the line of sight of a user U141 is guided from a start position P141 located in front of the user U141 to an end position P143 located behind the user U141. Specifically, in the example illustrated in FIG. 11, a route R141 making a detour above the head of the user U141 is set as the route connecting from the start position P141 to the end position P143, and a guidance object V141 is controlled so as to be localized along the R141.

Furthermore, in a situation where the guidance object (i.e., the virtual object) is presented to guide the line of sight of the user, it is sometimes difficult for the user to have a sense of distance (i.e., the distance from the start position to the end position) regarding the guidance of the line of sight. In consideration of such a situation, the information processing system according to the present modification controls the presentation mode of the guidance object so as to make it easier to have a sense of distance regarding the guidance of the line of sight.

Specifically, the information processing system according to the present modification may control the trajectory of the guidance object (i.e., the route for guiding the line of sight) in accordance with the distance (i.e., the distance from the start position to the end position) regarding the guidance of the line of sight. For example, in the case of the example illustrated in FIG. 11, the information processing system may control a height h of the trajectory of the guidance object V141 or an angle θ of the trajectory with respect to the horizontal plane in accordance with the distance between the start position P141 and the end position P143. More specifically, the information processing system may perform control such that the angle θ of the trajectory of the guidance object V141 is smaller (that is, the height h of the trajectory is lower) when the distance regarding the guidance of the line of sight is farther. On the other hand, the information processing system may perform control such that the angle θ of the trajectory of the guidance object V141 is larger (that is, the height h of the trajectory is higher) when the distance regarding the guidance of the line of sight is closer.

Furthermore, the information processing system may control the movement of the guidance object in accordance with the distance regarding the guidance of the line of sight. For example, in the case of the example illustrated in FIG. 11, the information processing system may control a velocity v of the moving guidance object V141 or the texture (e.g., a feeling of weight or inertia) of the moving guidance object V141 in accordance with the distance between the start position P141 and the end position P143. More specifically, the information processing system may perform control such that the velocity v of the guidance object V141 is faster and the texture of the guidance object V141 is lighter when the distance regarding the guidance of the line of sight is farther (i.e., the distance is longer). On the other hand, the information processing system may perform control such that the velocity v of the guidance object V141 is slower and the texture of the guidance object V141 is heavier when the distance regarding the guidance of the line of sight is closer (i.e., the distance is shorter).

Furthermore, the information processing system may control the output of sound in accordance with the movement of the guidance object to present the distance regarding the guidance of the line of sight to the user. In a specific example, the information processing system may perform control such that, when the distance regarding the guidance of the line of sight is farther, the sound is output to evoke a quicker movement of the guidance object. On the other hand, the information processing system may perform control such that, when the distance regarding the guidance of the line of sight is closer, the sound is output to evoke a slower movement of the guidance object.

Furthermore, two or more of the above-described examples of the control may be used in combination. Moreover, each of the above-described examples of the control is merely an example, and there is no particular limitation on the details of the control as long as it is possible to evoke the distance in the user due to a change in the control in accordance with the distance regarding the guidance of the line of sight.

An example of the control regarding the presentation of the guidance object has been described above as the modification 1-2 with reference to FIG. 11.

(Modification 1-3: Example of the Control in Consideration of Blocking Object)

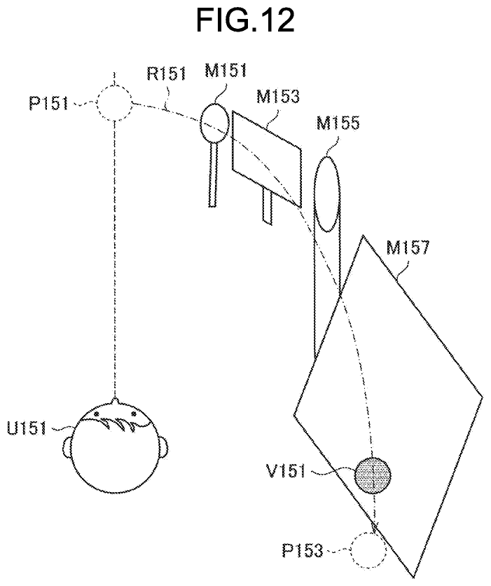

Next, as a modification 1-3, an example of the control in a situation where the presented guidance object is blocked by an object positioned around the user is described. For example, FIG. 12 to FIG. 14 are explanatory diagrams illustrating the overview of the information processing system according to the modification 1-3 of the present embodiment.

In some positional relationships among the position of the viewpoint, the point of gaze (i.e., the start position), and the guidance destination (i.e., the end position) of the line of sight, an object such as an actual object or a virtual object, may be interposed between the user and the guidance object, and the guidance object may be blocked by the object. In particular, when the AR technology or the VR technology is used, it is possible to assume a situation in which a possible object (hereinafter also referred to as “blocking object”), such as a sign, a signboard, a poster, a pole, or a wall surface, which blocks the guidance object in the field of view of the user, is present around the user. Furthermore, it is possible to assume a situation where the object, which may be a blocking object, has various sizes and shapes, for example, it is smaller than the guidance object, it is larger than the guidance object, it has a rod-like shape, or it has a wider area.

In a specific example, FIG. 12 illustrates an example of the case in which real objects M151 to M157 are positioned around a user U151 and the line of sight of the user U151 is guided from a start position P151 to an end position P153. In this case, for example, a route R151 is set in accordance with the positional relationship among the position (i.e., the position of the viewpoint) of the user U151, the start position P151, and the end position P153, and a guidance object V151 is presented to the user U151 such that it is localized along the R151.

Furthermore, if at least part of the route R151 is positioned at the back side of at least any one of the real objects M151 to M157 when viewed from the user U151, the guidance object V151 is blocked by the object at the part. In such a situation, it may be expected that the user U151 misses the guidance object V151 and, as a result, the guidance of the line of sight of the user U151 is difficult.

Therefore, in the information processing system according to the modification 1-3, even in a situation where the blocking object blocks the guidance object, for example, the presentation mode of information (for example, the presentation mode of visual information) to the user is controlled so that the guidance of the line of sight of the user may be continued.

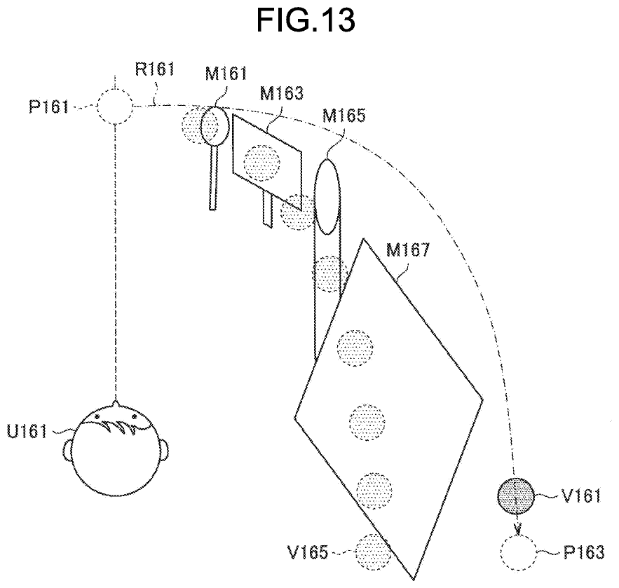

For example, FIG. 13 illustrates an example of the control in a case where it is difficult to temporarily move the target object (i.e., the object that may be a blocking object), such as an actual object, or temporarily suppress (for example, temporarily delete) the presentation. Specifically, FIG. 13 illustrates an example of the case where real objects M161 to M167 are positioned around a user U161 and the line of sight of the user U161 is guided from a start position P161 to an end position P163. More specifically, FIG. 13 schematically illustrates an example of the situation in which the real objects M161 to M167 are interposed between the user U161 and a route R161 for guiding the line of sight of the user U161.

In the case illustrated in FIG. 13, for example, the information processing system may control the position at which the guidance object V161 is localized. In a specific example, the information processing system may perform control such that the guidance object V161 is localized on the front side (i.e., at the position closer to the user U161) of the blocking object V161 when the size of the blocking object is more than several times as large as the size of the guidance object V161. Due to this control, it is possible to prevent the occurrence of the situation in which the user U161 misses the guidance object V161 as the guidance object V161 is blocked by the blocking object.

Furthermore, the information processing system may control the presentation mode of the guidance object V161. In a specific example, the information processing system may perform control such that the size of the guidance object V161 becomes larger (for example, larger than that of the blocking object) when the size of the blocking object is less than several times as large as the size of the guidance object V161. Due to this control, even when the guidance object V161 is blocked by the blocking object, the user U161 may visually recognize at least part of the guidance object V161. Furthermore, there is no particular limitation on the details of the control on the presentation mode of the guidance object V161 as long as the user U161 may visually recognize at least part of the guidance object V161 even though the guidance object V161 is blocked by the blocking object.

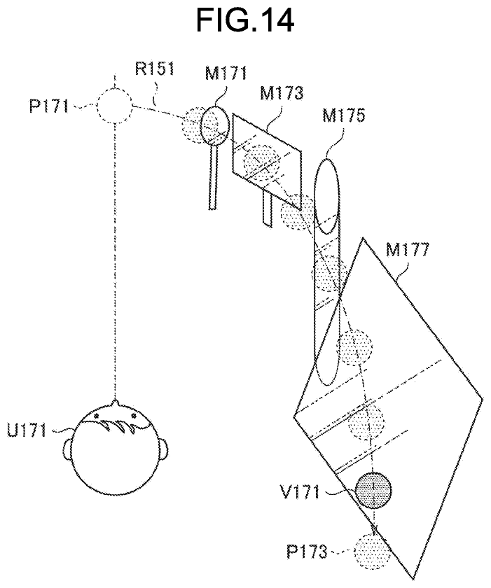

Furthermore, the information processing system may use visual presentation (e.g., light or residual image) to cause the user to recognize the guidance object V161 positioned on the back side of the blocking object when the guidance object V161 is blocked by the blocking object. For example, in the example illustrated in FIG. 14, the information processing system presents different display information V165 (in other words, display information (a different guidance object) that is an alternative for the guidance object V161) in accordance with the position of the localized guidance object V161 on the front side of the blocking object (e.g., the real objects M161 to M167) when the guidance object V161 is positioned on the back side of the blocking object. In a specific example, the display information V165 may be presented at the position corresponding to the front side of the blocking object between the position of the viewpoint of the user U161 and the position of the localized guidance object V161. Thus, the display information V165 allows the user U161 to recognize the guidance object V161 positioned on the back side of the blocking object even when the guidance object V161 is blocked by the blocking object.

Furthermore, there is no particular limitation on the display mode of the display information V165 as long as the user U161 may recognize the guidance object V161 positioned on the back side of the blocking object. For example, the information processing system may perform control such that the display information V165 is presented on the front side of the blocking object so as to follow the guidance object V161 that moves along the route R161. Moreover, in another example, the information processing system may perform control such that the one or more pieces of display information V165 are presented on the front side of the blocking object along the trajectory of the moving guidance object V161.

Furthermore, FIG. 14 illustrates an example of the control in a case where it is possible to temporarily move the target object (i.e., the object that may be a blocking object), such as a virtual object, or temporarily suppress (for example, temporarily delete) the presentation. Specifically, FIG. 14 illustrates an example of the case where virtual objects M171 to M177 are positioned around a user U171 and the line of sight of the user U171 is guided from a start position P171 to an end position P173.

In the situation illustrated in FIG. 14, the presentation modes of the virtual objects M171 to M177 as well as the presentation mode of the guidance object V171 may be controlled by the information processing system side in some cases. In this case, for example, the information processing system may control the color and the transparency of the blocking object so that the user U171 may visually recognize the guidance object V171 positioned on the back side of the blocking object (e.g., the virtual objects M171 to M177). Due to this control, the user U171 may visually recognize the guidance object V171 positioned on the back side of the blocking object. Moreover, here, the information processing system may control the display mode (e.g., the size) of the guidance object V171 such that the user U171 easily recognizes a sense of distance with the guidance object V171.

An example of the control in a situation where the presented guidance object is blocked by an object positioned around the user has been described above as the modification 1-3 with reference to FIG. 12 to FIG. 14.

### OTHER APPLICATION EXAMPLES

Next, other application examples of the information processing system according to the present embodiment are described.

For example, there is no particular limitation on the presentation mode (e.g., the shape) of the guidance object presented to the user. In a specific example, the guidance route (trajectory) of the line of sight may be presented by using a guidance object having a shape such as a line or a triangle. Furthermore, the guidance object having a shape such as an arrow or a circle may be used. Moreover, the ease of recognition of the guiding direction and the ease of guidance of the line of sight of the user are different depending on the display mode (shape) of the guidance object. Therefore, the display mode of the guidance object may be changed as appropriate depending on the expected use case. Moreover, the display mode of the guidance object may be dynamically changed in accordance with the situation at the time.

Furthermore, the information processing system may sequentially monitor the line of sight of the user and, in accordance with a monitoring result, control an operation regarding the guidance of the line of sight of the user (for example, an operation regarding the presentation of the guidance object). For example, when the presentation position or the trajectory of the guidance object does not match the movement of the line of sight of the user (for example, the change in the position of the point of gaze or the movement of the user's head), it may be assumed that the user has missed the guidance object or the user has become interested in a different thing. For this reason, in such a case, for example, the information processing system may reset the point of gaze at the moment as a new start position and may start the guidance of the line of sight again from the newly set start position. Further, in another example, the information processing system may control the display mode of the guidance object, for example, decrease the moving velocity of the guidance object near the point of gaze at the moment or flashes the guidance object so as to draw the user's attention.

Furthermore, it is also expected that, with regard to the route for the guidance of the line of sight of the user, at least part of it does not fall within the field of view of the user, which makes it difficult for the user to know the entire route or the situation at that moment. Therefore, the additional information may be presented to the user so as to know the entire route for the guidance of the line of sight. In a specific example, the overview of the movement of the user and the position that is the guidance destination of the line of sight of the user may be presented to prompt the user to easily turn the line of sight to the position that is the guidance destination. Further, there is no particular limitation on the mode of the information presented at the above case. For example, the avatar (UI object) representing the user may be presented so that the state of the user is presented to the user. Moreover, the additional information presented to the user as described above corresponds to an example of “third information”.

Furthermore, the display mode of the guidance object may be controlled in accordance with the positional relationship between the start position and the end position so that the user may recognize the movement of the guidance object more easily. In a specific example, the moving velocity of the guidance object may be controlled to be slower when the start position and the end position are located in the vicinity in the field of view of the user. Furthermore, in a situation where the start position and the end position are further spaced apart from each other, the moving velocity of the guidance object may be controlled to be faster or the movement of the guidance object may be controlled to be discrete.

Furthermore, in some cases, the user rapidly moves a predetermined site (e.g., the neck or the head) in accordance with the positional relationship between the start position and the end position. In such a case, for example, after the start position is moved to a position further away from the user, the guidance of the line of sight of the user may be started. This control may achieve a smoother movement of the site of the user in accordance with the guidance of the line of sight and a reduction in the load on the user.

Further, an animation expression may be used for the presentation of the guidance object. In this case, for example, as the animation display of the guidance object, “the initial velocity”, “the terminal velocity”, “the type of animation curve”, and the like, are controlled so that the animation regarding the transition from the start position to the end position may be controlled to be smoother (in other words, become more natural movement).

Furthermore, various types of information may be presented to the user in accordance with the presentation mode of the guidance object. In a specific example, the velocity of the movement of the guidance object may be controlled in accordance with the level of urgency. Thus, the level of urgency may be presented to the user in accordance with the velocity of the movement of the guidance object.

The other application examples of the information processing system according to the present embodiment have been described above.

<3. 5. Evaluation>

As described above, the information processing system (e.g., the information processing apparatus 10) according to the present embodiment acquires the information on the self-location of the user, the detection result of the line of sight of the user, the posture of the site of the user, and the like, and uses the information for the guidance of the line of sight of the user. Further, the information processing system performs control such that the second information for guiding the line of sight of the user is presented to the user. Here, the information processing system controls, based on the acquired information, the above-described second information so as to be localized in a route having a lower following load on the user with regard to the second information out of a first route and a second route connecting the start position and the end position regarding the guidance of the line of sight in accordance with the second coordinate that is independent of the first coordinate associated with the output unit.

With the configuration described above, the information processing system according to the present embodiment makes it possible to further reduce a load (e.g., a physical load or a mental load) on the user when the user causes the line of sight to follow the guidance object.

### 4. SECOND EMBODIMENT

Next, an information processing system according to a second embodiment of the present disclosure is described.

<4. 1. Overview>

First, the overview of the information processing system according to the present embodiment is described. As described above, in a situation where the AR technology or the VR technology is used, it is also assumed that the target information to be presented is localized outside the field of view of the user, and the mechanism that may guide the line of sight of the user in a more preferable manner is important so as to cause the user to find the information.

Furthermore, in order to direct the line of sight to the information localized outside the field of view, the user sometimes needs to move each site of the body such as the eye, the neck, the head, the chest, or the waist, which may result in a physical load on the user in some route for the guidance of the line of sight. Therefore, according to the present embodiment, with regard to the guidance of the line of sight of the user, the mechanism that further reduces a following load on the user during the guidance is described with a focus on, particularly, the case where a physical load on the user is reduced.

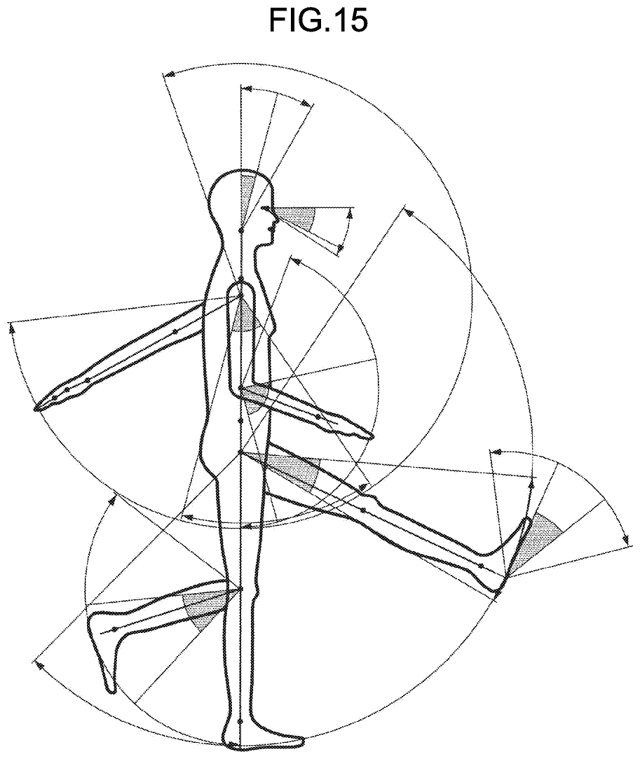

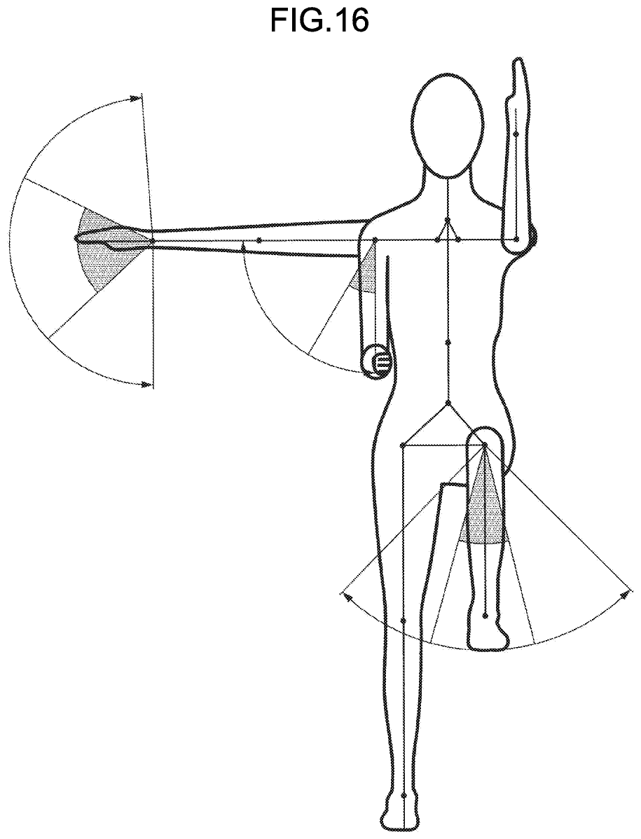

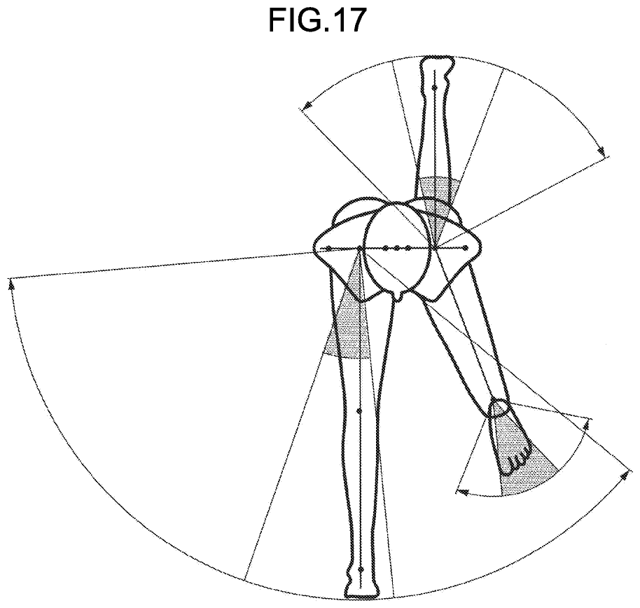

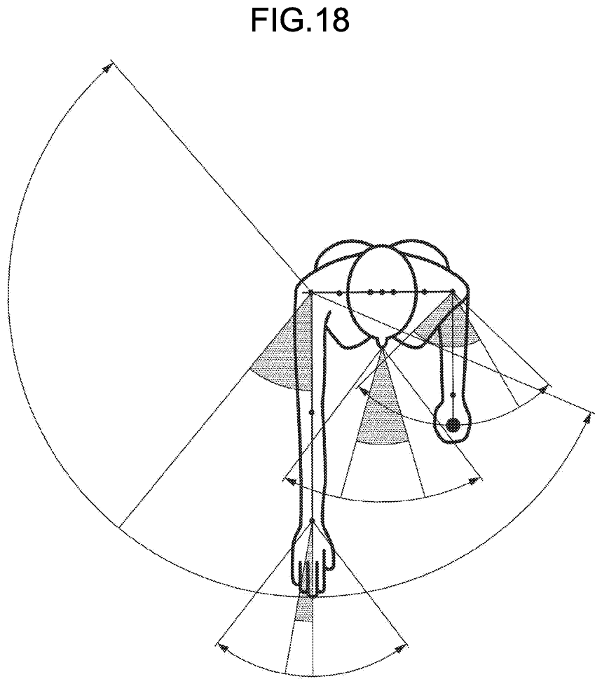

Specifically, the information processing system according to the present embodiment detects the posture of each site of the user and, in accordance with the movable range of each site (in particular, a site that is moved during the guidance of the line of sight) of the user corresponding to the posture, controls the route for the guidance of the line of sight of the user. For example, FIG. 15 to FIG. 18 are explanatory diagrams illustrating the overview of the information processing system according to the present embodiment and schematically illustrating the movable range of each site of a human body. For example, in a situation where the user moves each site of his/her body, there is a range in which a physical load is low during the movement of the target site (for example, a feeling of fatigue during the movement of the site is unlikely to occur) within the movable range of the site. For example, in FIG. 15 to FIG. 18, a hatched range in the movable range of each site indicated by a double-headed arrow schematically indicates the range of a lower physical load during the movement of the target site.

That is, the information processing system according to the present embodiment controls the route for the guidance of the line of sight so as to further decrease a load (i.e., a physical load) on the user in consideration of a load on each site that is expected to move during the guidance of the line of sight. Therefore, the operation of the information processing system according to the present embodiment is described in more detail below.

<4. 2. Process>

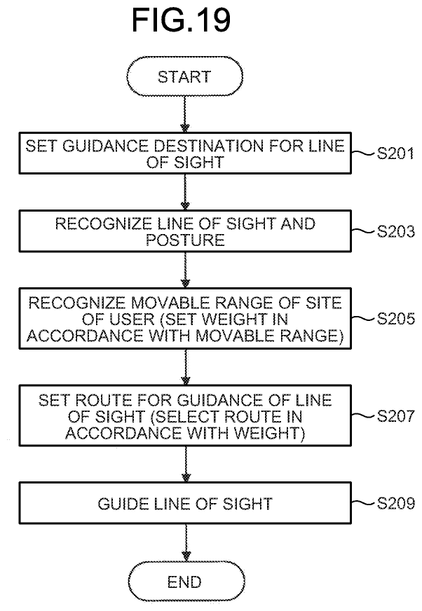

First, an example of the flow of the series of processes in the information processing system according to the present embodiment is described with reference to FIG. 19 with a focus on, particularly, an operation regarding the guidance of the line of sight of the user by the information processing apparatus 10. FIG. 19 is a flowchart illustrating an example of the flow of the series of processes in the information processing system according to the present embodiment. In this description, for the sake of convenience, an example of the operation of the information processing system (in particular, the operation of the information processing apparatus 10) is described based on the assumption that the information processing system according to the present embodiment includes the functional configuration as described with reference to FIG. 5.

First, the information processing apparatus 10 (the guidance control unit 113) sets the guidance destination for the line of sight (S201). For example, the information processing apparatus 10 may set the position where the display information (e.g., the virtual object), which needs to be noticed by the user, is localized as the guidance destination of the line of sight of the user.

Subsequently, the information processing apparatus 10 (the line-of-sight detection unit 107) detects the line of sight of the user based on various types of information acquired by the input/output device 20 and recognizes the positions of the viewpoint and the point of gaze based on the detection result. Furthermore, based on various types of information acquired by the input/output device 20, the information processing apparatus (the posture detection unit 109) recognizes the posture of at least a part (in particular, the site that is expected to move when the user moves the line of sight) of the sites of the user's body (S203). In a specific example, the information processing apparatus 10 may recognize the posture of the site, such as the user's head, chest, waist, or four limbs, as the target. Furthermore, there is no particular limitation on the configuration and the method as long as it is possible to recognize (or detect) the posture of the target site. In a specific example, the detection result of an acceleration sensor or an angular velocity sensor held by the target site may be used to recognize the posture of the site.

Subsequently, the information processing apparatus 10 (the guidance control unit 113) applies a weight to the range in the moving direction of each site in consideration of the movable range of the site in accordance with the recognition result of the posture of the site so as to apply a weight to the route for the guidance of the line of sight. Then, the information processing apparatus 10 sets (selects) the route for the guidance of the line of sight of the user in accordance with the result of the weighting (S207).

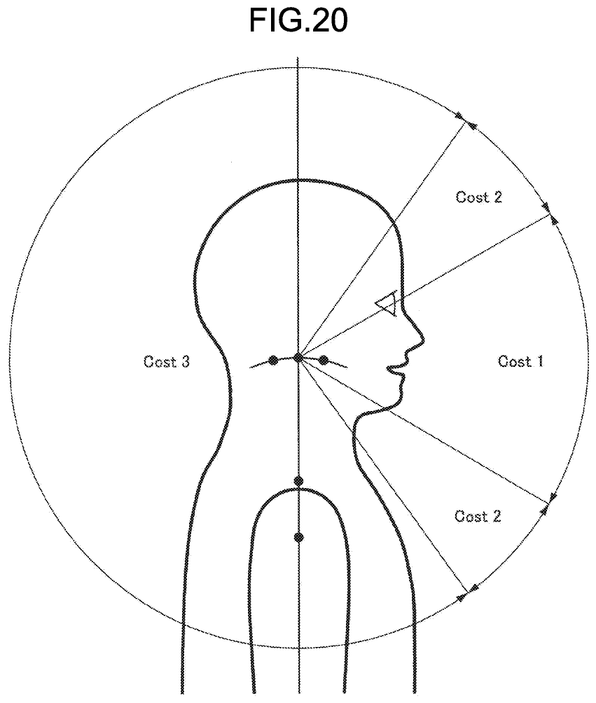

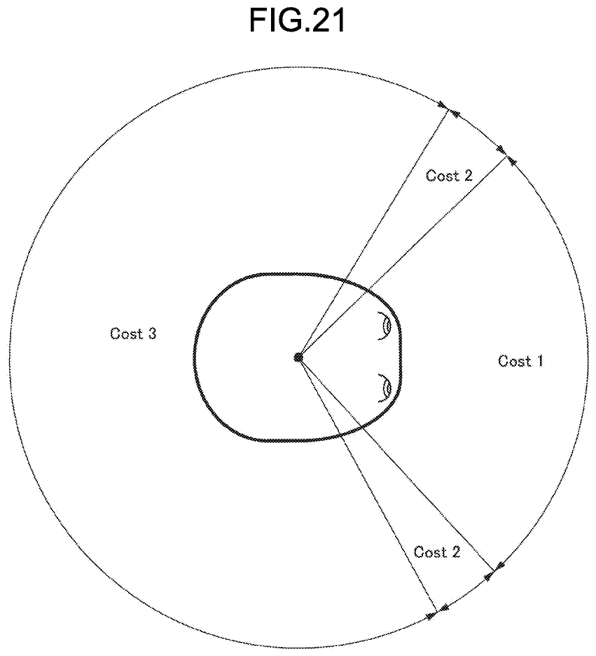

Here, with reference to FIG. 20 and FIG. 21, the operation regarding the setting of the route for the guidance of the line of sight of the user by the information processing apparatus 10 is described by using a specific example. For example, FIG. 20 and FIG. 21 are explanatory diagrams illustrating an example of the control regarding the guidance of the line of sight of the user by the information processing system according to the present embodiment and illustrating an example of the weighting with a focus on the head.

For example, FIG. 20 illustrates an example of the case where weighting is executed in consideration of the movable range of the head with respect to the range in the vertical direction when the head is moved in the vertical direction. Furthermore, FIG. 21 illustrates an example of the case where weighting is executed in consideration of the movable range of the head with respect to the range in the horizontal direction when the head is moved in the horizontal direction. The examples illustrated in FIG. 20 and FIG. 21 indicate that the lower the associated cost, the lower the physical load on the user. That is, the larger the rotation angle of the head in the vertical direction and the horizontal direction, the larger the physical load on the user.

Furthermore, when it is assumed that the site such as the neck or the trunk (e.g., the chest or the waist) is moved, the load on the user tends to be smaller in a case where the site is moved (for example, rotated) in the horizontal direction as compared to the case where the site is moved in the vertical direction. Due to these characteristics, for example, with regard to a site such as the neck or the trunk, a lower cost is set for the movement in the horizontal direction than that for the movement in the vertical direction.

Furthermore, it may be assumed that the load on each site of the user during the movement of the line of sight changes in accordance with the posture of the site at the moment. For example, when the head is tilted upward, the action of further tilting the head upward causes a high load on the user. Therefore, in this case, a higher cost may be set to the range of the further upward tilting of the head. That is, a higher cost is set to the range of a further movement of the site beyond the movable range of the site.

Furthermore, there is no particular limitation on the method for setting the candidate route to be selected. In a specific example, the information processing apparatus 10 may use a route selection algorithm such as Dijkstra's algorithm to set the candidate route to be selected.

As described above, the information processing apparatus 10 may calculate the cost for each of one or more routes for the guidance of the line of sight of the user and set a route having a lower cost (for example, the route having the minimum cost) as a route for the guidance of the line of sight of the user.

Then, the information processing apparatus 10 (the guidance control unit 113) guides the line of sight of the user along the set route (S209). In a specific example, as described above in the first embodiment, the information processing apparatus 10 may perform control such that the guidance object is localized along the set route so as to guide the line of sight of the user.

An example of the flow of the series of processes in the information processing system according to the present embodiment has been described above with reference to FIG. 19 with a focus on, particularly, the operation regarding the guidance of the line of sight of the user by the information processing apparatus 10.

<4. 3. Modification>

Next, a modification of the information processing system according to the present embodiment is described. In the present modification, an explanation is given of an example of the operation of setting the level of priority for each site in accordance with the purpose of guiding the line of sight of the user and setting the route for the guidance of the line of sight of the user based on the level of priority of the site.

In a specific example, there may be a difference in the guidance method that may further reduce the load on the user due to a series of operations in a case where the user is simply caused to turn the line of sight to a certain object and in a case where the user is requested to perform the operation to touch the object with the hand after directing the line of sight. Specifically, when the user is requested to perform the operation to touch the object with the hand after the user directs the line of sight to the object, it is desirable that the user is in the posture so as to easily touch the object after the guidance of the line of sight.

For example, to simply direct the line of sight of the user to a certain object, for example, the eyeball, the head (neck), the trunk, and the foot may be set as the site whose movable range is considered, and the level of priority may be set in this order. Specifically, first, it is determined whether the line of sight may be guided by using the movement of the line of sight due to only the movement of the eyeball, and then it is determined whether the line of sight may be guided to the target object by using, sequentially, a change in the direction of the head (neck), a change in the direction of the trunk, and the movement by the foot. That is, in this case, for example, when it is determined that the line of sight may be guided to the target object by using only a change in the directions of the eyeball and the head, a determination may be omitted for the guidance of the line of sight in consideration of a change in the direction of the trunk and the movement by the foot.

Furthermore, in a case where the user is requested to perform the operation to touch the target object with the hand after the guidance of the line of sight, it is desirable to guide the user so as to be in the posture such that the object is positioned within the movable range of the user's hand or arm (in particular, within the range where the user is less likely to have a feeling of fatigue) after the guidance of the line of sight. For this reason, in this case, for example, it is desirable to consider the movable ranges of the wrist, the elbow, and the shoulder for the guidance of the line of sight.

Furthermore, in a case where the target object is touched with the hand (that is, in a case where the touch with the hand is guided), too, the level of priority may be set for each site, and a determination may be made in accordance with the level of priority. Specifically, first, it may be determined whether the target object may be touched by using only a change in the direction of the wrist, and then it may be determined whether the target object may be touched by using, sequentially, a change in the direction of the elbow and a change in the direction of the shoulder. That is, in this case, for example, when it is determined that the target object may be touched by using only changes in the directions of the wrist and the elbow, it is possible to omit a determination on the guidance of the touch with the hand in consideration of a change in the direction of the shoulder.

Furthermore, the above-described example is merely an example and does not necessarily limit the target site of which the movable range is considered or the details of the control regarding the guidance in consideration of the movable range of the site. That is, based on the assumption of the use case of the information processing system according to the present embodiment, the target site of which the movable range is considered for the guidance or the details of the control regarding the guidance may be changed as appropriate.

As the modification of the information processing system according to the present embodiment, an example of the operation of setting the level of priority for each site in accordance with the purpose of guiding the line of sight of the user and setting a route for the guidance of the line of sight of the user based on the level of priority of each site has been described above.

<4. 4. Evaluation>

As described above, the information processing system (for example, the information processing apparatus 10) according to the present embodiment acquires the information on the posture of the user and uses the information for the guidance of the line of sight of the user. Further, the information processing system performs control such that the second information for guiding the line of sight of the user is localized along the route having a lower following load (for example, a physical load) on the user on the basis of the movable range of the site of the user corresponding to the posture of the user.

With the above-described configuration, the information processing system according to the present embodiment may further reduce a load (e.g., a physical load) on the user when the user causes the line of sight to follow the guidance object.

### 5. HARDWARE CONFIGURATION

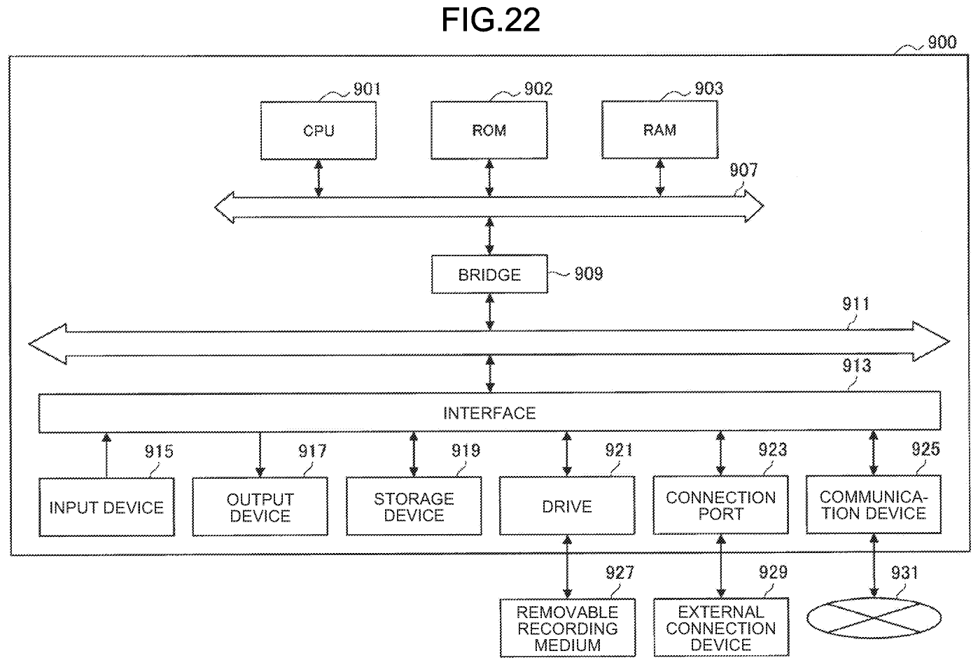

Next, the hardware configuration of an information processing apparatus 900, such as the information processing apparatus 10 and the input/output device 20 described above, included in the information processing system 1 according to the present embodiment is described in detail with reference to FIG. 22. FIG. 22 is a functional block diagram illustrating an example of the hardware configuration of the information processing apparatus 900 included in the information processing system 1 according to an embodiment of the present disclosure.

The information processing apparatus 900 included in the information processing system 1 according to the present embodiment primarily includes a CPU 901, a ROM 903, and a RAM 905. Further, the information processing apparatus 900 further includes a host bus 907, a bridge 909, an external bus 911, an interface 913, an input device 915, an output device 917, a storage device 919, a drive 921, a connection port 923, and a communication device 925.

The CPU 901 functions as an arithmetic processing device and a control device to control all or some of the operations in the information processing apparatus 900 in accordance with various programs recorded in the ROM 903, the RAM 905, the storage device 919, or a removable recording medium 927. The ROM 903 stores a program, an arithmetic parameter, and the like, used by the CPU 901. The RAM 905 primarily stores a program used by the CPU 901, a parameter that is appropriately changed during the execution of a program, and the like. They are connected to each other via a host bus 907 including an internal bus such as a CPU bus. Furthermore, the recognition processing unit 101, the detection unit 103, the processing execution unit 109, and the output control unit 111 described above with reference to FIG. 5 may be implemented by using, for example, the CPU 901.

The host bus 907 is connected to an external bus 911, such as a PCI (Peripheral Component Interconnect/Interface) bus, via a bridge 909. Further, the external bus 911 is connected to the input device 915, the output device 917, the storage device 919, the drive 921, the connection port 923, and the communication device 925 via the interface 913.

The input device 915 is an operating means operated by the user, such as a mouse, a keyboard, a touch panel, a button, a switch, a lever, or a pedal. Furthermore, the input device 915 may be, for example, a remote control means (what is called a remote) using infrared rays or other radio waves or may be an external connection device 929 such as a mobile phone or a PDA corresponding to the operation of the information processing apparatus 900. Further, the input device 915 includes, for example, an input control circuitry that generates an input signal on the basis of the information input by the user using the above-described operating means and outputs it to the CPU 901. The user of the information processing apparatus 900 may operate the input device 915 to input various types of data or instruct processing operations to the information processing apparatus 900.

The output device 917 includes a device capable of visually or audibly notifying the user of acquired information. Examples of such a device include a display device such as a CRT display device, a liquid crystal display device, a plasma display device, an EL display device, or a lamp, a sound output device such as a speaker and a headphone, a printer device, and the like. The output device 917 outputs, for example, results obtained during various types of processing performed by the information processing apparatus 900. Specifically, the display device presents the results obtained during various processes performed by the information processing apparatus 900 by using a text or image. Furthermore, the sound output device converts an audio signal including reproduced sound data, audio data, or the like, into an analog signal, and outputs it. Furthermore, the output unit 210 described above with reference to FIG. 5 may be implemented by using, for example, the output device 917.

The storage device 919 is a data storage device that is configured as an example of a storage unit of the information processing apparatus 900. The storage device 919 includes, for example, a magnetic storage device such as an HDD (Hard Disk Drive), a semiconductor storage device, an optical storage device, or a magneto-optical storage device. The storage device 919 stores a program executed by the CPU 901, various types of data, and the like.

The drive 921 is a reader/writer for a recording medium and is built in or externally attached to the information processing apparatus 900. The drive 921 reads the information recorded in the attached removable recording medium 927, such as a magnetic disk, an optical disk, a magneto-optical disk, or a semiconductor memory, and outputs it to the RAM 905. Furthermore, the drive 921 may also write records in the attached removable recording medium 927 such as a magnetic disk, an optical disk, a magneto-optical disk, or a semiconductor memory. The removable recording medium 927 is, for example, a DVD medium, an HD-DVD medium, or a Blu-ray (registered trademark) medium. Furthermore, the removable recording medium 927 may be a compact flash (registered trademark) (CF: CompactFlash), a flash memory, an SD memory card (Secure Digital memory card), or the like. Further, the removable recording medium 927 may be, for example, an IC card (Integrated Circuit card) including a non-contact IC chip, an electronic device, or the like. Moreover, the storage unit 190 described above with reference to FIG. 6 may be implemented by using, for example, at least any one of the RAM 905 and the storage device 919.

The connection port 923 is a port for directly connecting to the information processing apparatus 900. Examples of the connection port 923 include a USB (Universal Serial Bus) port, an IEEE 1394 port, or an SCSI (Small Computer System Interface) port. Other examples of the connection port 923 include an RS-232C port, an optical audio terminal, or an HDMI (registered trademark) (High-Definition Multimedia Interface) port. The external connection device 929 is coupled to the connection port 923 so that the information processing apparatus 900 directly acquires various types of data from the external connection device 929 or provides various types of data to the external connection device 929.

The communication device 925 is, for example, a communication interface including a communication device, or the like, to connect to a communication network (network) 931. The communication device 925 is, for example, a communication card for a wired or wireless LAN (Local Area Network), Bluetooth (registered trademark), or WUSB (Wireless USB). Furthermore, the communication device 925 may be a router for optical communication, a router for ADSL (Asymmetric Digital Subscriber Line), a modem for various types of communication, or the like. For example, the communication device 925 may transmit and receive signals, and the like, to and from the Internet or other communication devices in accordance with a predetermined protocol such as TCP/IP. Further, the communication network 931 connected to the communication device 925 includes a network connected by wire or wirelessly, and may be, for example, the Internet, a LAN for home, infrared communication, radio wave communication, satellite communication, or the like.

An example of the hardware configuration that may implement the function of the information processing apparatus 900 included in the information processing system 1 according to the embodiment of the present disclosure has been described above. Each of the above-described components may be configured by using a general-purpose member or may be configured by using the hardware dedicated to the function of each component. Therefore, it is possible to appropriately change the hardware configuration to be used depending on the technical level of the present embodiment implemented. Although not illustrated in FIG. 22, it is obvious that various configurations corresponding to the information processing apparatus 900 included in the information processing system 1 according to the present embodiment are provided.

Furthermore, a computer program for executing each function of the information processing apparatus 900 included in the information processing system 1 according to the present embodiment as described above may be generated and installed in a personal computer, or the like. Further, a computer-readable recording medium storing the above computer program may be provided. The recording medium is, for example, a magnetic disk, an optical disk, a magneto-optical disk, or a flash memory. Further, the above-described computer program may be distributed via, for example, a network without using a recording medium. Moreover, there is no particular limitation on the number of computers that execute the computer program. For example, the computer program may be executed by a plurality of computers (e.g., a plurality of servers) in cooperation with each other. Here, a single computer or a plurality of computers in cooperation is also referred to as a “computer system”.

### 6. CONCLUSION

Although preferred embodiments of the present disclosure have been described above in detail with reference to the accompanying drawings, the technical scope of the present disclosure is not limited to such examples. It is apparent that those skilled in the art according to the present disclosure may arrive at various changes or modifications within the range of the technical idea described in the scope of claims, and it is understood that these are also obviously included in the technical range of the present disclosure.

Furthermore, the above description is given with a focus on the case where the display information, such as the guidance object, is primarily presented to the user so as to guide the line of sight of the user. However, there is no particular limitation on the type of information presented to the user for the guidance as long as it is possible to guide the line of sight of the user along the desired route. In a specific example, the direction in which the sound having directional characteristics is output (i.e., the direction in which the sound comes to the user) may be controlled to guide the line of sight of the user along the desired route. Furthermore, in another example, a tactile sense or a force sense may be presented to the user so as to guide the line of sight of the user.

Furthermore, the advantages described in this description are for the purpose of explanation or exemplification and not limitation. That is, the technology according to the present disclosure may produce other advantages that are apparent to those skilled in the art from this description in addition to or instead of the above-described advantages.

Furthermore, the following configuration also belongs to the technical range of the present disclosure.

(1)

An information processing apparatus comprising:

an acquisition unit that acquires first information regarding guidance of a line of sight of a user; and

a control unit that controls second information to be presented to the user so as to guide the line of sight of the user, wherein

the control unit controls, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

(2)

The information processing apparatus according to (1), wherein

the first information includes information about a position of the user, and

the second route is a route that is farther away from the user as compared with the first route.

(3)

The information processing apparatus according to (2), wherein when the first route passes through the user or passes through an area near the user, the control unit controls the second information so as to be localized along the second route.

(4)

The information processing apparatus according to any one of (1) to (3), wherein

the output unit is a display unit,

the second information is a guidance object that is presented to be visually recognizable via the display unit, and

the control unit controls the guidance object so as to be presented along a route having the lower following load.

(5)

The information processing apparatus according to (4), wherein when there is a blocking object between the user and the second route, the control unit controls the guidance object so as to be presented at a position corresponding to the second route between the blocking object and the user.

(6)

The information processing apparatus according to (4), wherein when there is a blocking object between the user and the guidance object, the control unit controls a presentation mode of the guidance object.

(7)

The information processing apparatus according to (4), wherein when there is a blocking object between the user and the guidance object, the control unit controls a different guidance object so as to presented at a position that is between the blocking object and the user and that corresponds to a position where the guidance object is localized.

(8)

The information processing apparatus according to (4), wherein when there is a virtual object between the user and the second route, the control unit controls presentation of the virtual object such that visibility of the virtual object is reduced at a display area of the display unit corresponding to the second route.

(9)

The information processing apparatus according to any one of (4) to (8), wherein the control unit controls a presentation mode of the guidance object in accordance with a distance between the start position and the end position.

(10)

The information processing apparatus according to (9), wherein the control unit controls, as the presentation mode of the guidance object, at least any of a moving velocity of the guidance object, a moving angle of the guidance object, inertia acting on the guidance object, and a sound presented in accordance with movement of the guidance object.

(11)

The information processing apparatus according to any one of (4) to (10), wherein the control unit controls the guidance object so as to be presented in a display area of the display unit corresponding to a field of view of the user at a start of the guidance of the line of sight from the start position to the end position.

(12)

The information processing apparatus according to (11), wherein the control unit controls presentation of the guidance object presented in a display area of the display unit such that the guidance object moves along the first route or the second route.

(13)

The information processing apparatus according to any one of (4) to (11), wherein the control unit controls a presentation mode of the guidance object in accordance with a result of the guidance of the line of sight.

(14)

The information processing apparatus according to any one of (1) to (13), wherein the control unit sets a position corresponding to the line of sight as the new start position in accordance with a result of the guidance of the line of sight.

(15)

The information processing apparatus according to any one of (1) to (14), wherein the control unit controls third information corresponding to a positional relationship between at least any of the start position and the end position and a position of the user so as to be presented to the user.

(16)

The information processing apparatus according to any one of (1) to (15), wherein

the first information includes information corresponding to a detection result of a posture of the user, and

the control unit controls the second information so as to be localized in a route having a lower following load on the user out of the first route and the second route based on a movable range of a site of the user corresponding to the posture.

(17)

The information processing apparatus according to (16), wherein the control unit specifies a route having a lower following load on the user based on a weight set in accordance with the movable range.

(18)

The information processing apparatus according to (16) or (17), wherein the control unit specifies a route having a lower following load on the user based on the movable range of each site in accordance with a level of priority of the site.

(19)

An information processing method for causing a computer to execute:

acquiring first information regarding guidance of a line of sight of a user;

controlling second information to be presented to the user so as to guide the line of sight of the user; and

controlling, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

(20)

A recording medium storing a program causing a computer to execute:

acquiring first information regarding guidance of a line of sight of a user;

controlling second information to be presented to the user so as to guide the line of sight of the user; and

controlling, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

### REFERENCE SIGNS LIST

1 INFORMATION PROCESSING SYSTEM
10 INFORMATION PROCESSING APPARATUS
101 RECOGNITION PROCESSING UNIT
103 DETECTION UNIT
105 LINE-OF-SIGHT DETECTION UNIT
107 POSTURE DETECTION UNIT
109 PROCESSING EXECUTION UNIT
111 OUTPUT CONTROL UNIT
113 GUIDANCE CONTROL UNIT
190 STORAGE UNIT
20 INPUT/OUTPUT DEVICE
201 IMAGING UNIT
203 IMAGING UNIT
207 OPERATING UNIT
210 OUTPUT UNIT
211 DISPLAY UNIT
213 SOUND OUTPUT UNIT
221 SENSING UNIT

1. An information processing apparatus comprising:
an acquisition unit that acquires first information regarding guidance of a line of sight of a user; and
a control unit that controls second information to be presented to the user so as to guide the line of sight of the user, wherein
the control unit controls, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

2. The information processing apparatus according to claim 1, wherein
the first information includes information about a position of the user, and
the second route is a route that is farther away from the user as compared with the first route.

3. The information processing apparatus according to claim 2, wherein when the first route passes through the user or passes through an area near the user, the control unit controls the second information so as to be localized along the second route.

4. The information processing apparatus according to claim 1, wherein
the output unit is a display unit,
the second information is a guidance object that is presented to be visually recognizable via the display unit, and
the control unit controls the guidance object so as to be presented along a route having the lower following load.

5. The information processing apparatus according to claim 4, wherein when there is a blocking object between the user and the second route, the control unit controls the guidance object so as to be presented at a position corresponding to the second route between the blocking object and the user.

6. The information processing apparatus according to claim 4, wherein when there is a blocking object between the user and the guidance object, the control unit controls a presentation mode of the guidance object.

7. The information processing apparatus according to claim 4, wherein when there is a blocking object between the user and the guidance object, the control unit controls a different guidance object so as to presented at a position that is between the blocking object and the user and that corresponds to a position where the guidance object is localized.

8. The information processing apparatus according to claim 4, wherein when there is a virtual object between the user and the second route, the control unit controls presentation of the virtual object such that visibility of the virtual object is reduced at a display area of the display unit corresponding to the second route.

9. The information processing apparatus according to claim 4, wherein the control unit controls a presentation mode of the guidance object in accordance with a distance between the start position and the end position.

10. The information processing apparatus according to claim 9, wherein the control unit controls, as the presentation mode of the guidance object, at least any of a moving velocity of the guidance object, a moving angle of the guidance object, inertia acting on the guidance object, and a sound presented in accordance with movement of the guidance object.

11. The information processing apparatus according to claim 4, wherein the control unit controls the guidance object so as to be presented in a display area of the display unit corresponding to a field of view of the user at a start of the guidance of the line of sight from the start position to the end position.

12. The information processing apparatus according to claim 11, wherein the control unit controls presentation of the guidance object presented in a display area of the display unit such that the guidance object moves along the first route or the second route.

13. The information processing apparatus according to claim 4, wherein the control unit controls a presentation mode of the guidance object in accordance with a result of the guidance of the line of sight.

14. The information processing apparatus according to claim 1, wherein the control unit sets a position corresponding to the line of sight as the new start position in accordance with a result of the guidance of the line of sight.

15. The information processing apparatus according to claim 1, wherein the control unit controls third information corresponding to a positional relationship between at least any of the start position and the end position and a position of the user so as to be presented to the user.

16. The information processing apparatus according to claim 1, wherein
the first information includes information corresponding to a detection result of a posture of the user, and
the control unit controls the second information so as to be localized in a route having a lower following load on the user out of the first route and the second route based on a movable range of a site of the user corresponding to the posture.

17. The information processing apparatus according to claim 16, wherein the control unit specifies a route having a lower following load on the user based on a weight set in accordance with the movable range.

18. The information processing apparatus according to claim 16, wherein the control unit specifies a route having a lower following load on the user based on the movable range of each site in accordance with a level of priority of the site.

19. An information processing method for causing a computer to execute:
acquiring first information regarding guidance of a line of sight of a user;
controlling second information to be presented to the user so as to guide the line of sight of the user; and
controlling, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.

20. A recording medium storing a program causing a computer to execute:
acquiring first information regarding guidance of a line of sight of a user;
controlling second information to be presented to the user so as to guide the line of sight of the user; and
controlling, based on the first information, the second information so as to be localized in a route having a lower following load on the user with regard to the second information out of a first route and a second route connecting a start position and an end position regarding the guidance of the line of sight in accordance with a second coordinate that is independent of a first coordinate associated with an output unit.
